(19) United States
(12) Patent Application Publication
(10) Pub. No.: US 2026/0087723 A1
(43) Pub. Date: Mar. 26, 2026

(54) SYSTEM AND METHOD FOR DEPTH COMPLETION AND THREE-DIMENSIONAL RECONSTRUCTION OF AN IMAGE AREA

(71) Applicant: GUANGDONG OPPO MOBILE TELECOMMUNICATIONS CORP., LTD., Dongguan (CN)

(72) Inventors: Cheolkon JUNG, Dongguan (CN); Wei ZHAO, Dongguan (CN)

(21) Appl. No.: 19/408,095

(22) Filed: Dec. 3, 2025

Related U.S. Application Data
(63) Continuation of application No. PCT/CN2023/098420, filed on Jun. 5, 2023.

(51) Int. Cl. G06T 15/04; G06T 15/20

(52) U.S. Cl. CPC G06T 15/04; G06T 15/205; G06T 2210/56

(57) ABSTRACT

A method of video processing is provided. The method may include inputting attribute data and a sparse-depth map associated with an image area into a sparse-depth completion network. The method may include generating a refined dense-depth map based on the attribute data and the sparse-depth map using the sparse-depth completion network. The method may include performing a three-dimensional (3D) reconstruction procedure based on the refined dense-depth map to generate a point cloud of the image area. The method may include performing a triangular-meshing procedure to generate a mesh model based on the point cloud of the image area. The method may include performing a texture-mapping procedure based on the mesh model and the attribute data to generate a textured mesh of the image area. The method may include performing a vertex-normal procedure based on the textured mesh to generate a 3D representation of the image area.

### CROSS-REFERENCE TO RELATED APPLICATIONS

This application is a continuation of International Application No. PCT/CN2023/098420, filed on Jun. 5, 2023, the disclosure of which is hereby incorporated by reference in its entirety.

### BACKGROUND

Embodiments of the present disclosure relate to video processing.

Digital video has become mainstream and is being used in a wide range of applications including digital television, video telephony, and teleconferencing. These digital video applications are feasible because of the advances in computing and communication technologies as well as efficient video processing techniques.

### SUMMARY

According to one aspect of the present disclosure, a method of video processing is provided. The method may include inputting, by a processor, attribute data and a sparse-depth map associated with an image area into a sparse-depth completion network. The method may include generating, by the processor, a refined dense-depth map based on the attribute data and the sparse-depth map using the sparse-depth completion network. The method may include performing, by the processor, a three-dimensional (3D) reconstruction procedure based on the refined dense-depth map to generate a point cloud of the image area. The method may include performing, by the processor, a triangular-meshing procedure to generate a mesh model based on the point cloud of the image area. The method may include performing, by the processor, a texture-mapping procedure based on the mesh model and the attribute data to generate a textured mesh of the image area. The method may include performing, by the processor, a vertex-normal procedure based on the textured mesh to generate a 3D representation of the image area.

According to another aspect of the present disclosure, a system for video processing is provided. The system may include a processor and memory storing instructions. The memory storing instructions, which when executed by a processor, may cause the processor to input attribute data and a sparse-depth map associated with an image area into a sparse-depth completion network. The memory storing instructions, which when executed by a processor, may cause the processor to generate a refined dense-depth map based on the attribute data and the sparse-depth map using the sparse-depth completion network. The memory storing instructions, which when executed by a processor, may cause the processor to perform a 3D-reconstruction procedure based on the refined dense-depth map to generate a point cloud of the image area. The memory storing instructions, which when executed by a processor, may cause the processor to perform a triangular-meshing procedure to generate a mesh model based on the point cloud of the image area. The memory storing instructions, which when executed by a processor, may cause the processor to perform a texture-mapping procedure based on the mesh model and the attribute data to generate a textured mesh of the image area. The memory storing instructions, which when executed by a processor, may cause the processor to perform a vertex-normal procedure based on the textured mesh to generate a 3D representation of the image area.

According to a further aspect of the present disclosure, a non-transitory computer-readable medium is provided. The non-transitory computer-readable medium storing instructions. The instructions, when executed by a processor of a video-processing system, cause the processor to input attribute data and a sparse-depth map associated with an image area into a sparse-depth completion network. The instructions, which when executed by a processor of a video-processing system, cause the processor to generate a refined dense-depth map based on the attribute data and the sparse-depth map using the sparse-depth completion network. The instructions, which when executed by a processor of a video-processing system, cause the processor to perform a 3D-reconstruction procedure based on the refined dense-depth map to generate a point cloud of the image area. The instructions, which when executed by a processor of a video-processing system, cause the processor to perform a triangular-meshing procedure to generate a mesh model based on the point cloud of the image area. The instructions, which when executed by a processor of a video-processing system, cause the processor to perform a texture-mapping procedure based on the mesh model and the attribute data to generate a textured mesh of the image area. The instructions, when executed by a processor of a video-processing system, cause the processor to perform a vertex-normal procedure based on the textured mesh to generate a 3D representation of the image area.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1A illustrates a flow diagram of an example structure for motion and multi-view stereo reconstruction.

FIG. 1B illustrates a flow diagram of an example Bundlefusion optimization procedure.

FIG. 2 illustrates a flow diagram for generating a single-view 3D scene reconstruction using an exemplary video-processing system, according to some embodiments of the present disclosure.

FIG. 3 illustrates a diagram of an exemplary network architecture of a sparse-depth completion component of the video-processing system of FIG. 2, according to some embodiments of the present disclosure.

FIG. 4 illustrates a diagram of an exemplary multi-affinity matrix convolutional spatial propagation networks (CSPN++) component of the video-processing system of FIG. 2, according to some embodiments of the present disclosure.

FIG. 5 illustrates a diagram of an exemplary camera projection pinhole model applied by a 3D-reconstruction component of the video-processing system of FIG. 2, according to some embodiments of the present disclosure.

FIG. 6A illustrates a diagram representing a visual comparison of sparse-depth completion performed using the exemplary network architecture of FIG. 3, according to some embodiments of the present disclosure.

FIG. 6B illustrates a graphical representation of root mean square error (RMSE) and mean absolute error (MAE) performance for different depth sparsities, according to some embodiments of the present disclosure.

FIG. 6C illustrates a diagram representing visual comparison of a 3D point-cloud scene for different depth sparsities, according to some embodiments of the present disclosure.

FIG. 7 illustrates a diagram of a 3D indoor point-cloud scene reconstruction from a single red-green-blue (RGB) depth (D) (RGB-D) image generated using the exemplary network architecture of FIG. 3, according to some embodiments of the present disclosure.

FIG. 8 illustrates a diagram of point clouds and 3D-mesh structures reconstructed from a single RGB-D image in indoor scenes generated by the exemplary network architecture of FIG. 3, according to some embodiments of the present disclosure.

FIG. 9 illustrates a diagram of a visual comparison of reconstructed results from different perspectives between point cloud and the textured mesh generated by the exemplary network architecture of FIG. 3, according to some embodiments of the present disclosure.

FIG. 10 illustrates a flowchart of an exemplary method of video processing, according to some embodiments of the present disclosure.

FIG. 11 is a block diagram illustrating an example of a computer system useful for implementing various embodiments set forth in the disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video processing systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video processing applications. As described herein, video processing includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block” and “unit” may be used interchangeably.

Two-dimensional (2D)-vision technology is mainly related to planar image processing, such as image classification and segmentation. In contrast, 3D-vision technology generates geometric information from natural scenes and uses depth maps to understand the entire field-of-view. 3D reconstruction has been widely used in applications such as autonomous driving, virtual reality, and 3D printing. Multi-view geometry reconstruction is one 3D-reconstruction method. The basic principle of multi-view geometry reconstruction is that it uses images taken from different angles to capture the target object, which it then uses to restore the 3D structure and appearance of the target object by analyzing the geometric relationships between these images. To implement this method, camera parameter estimation and dense point-cloud reconstruction may be applied.

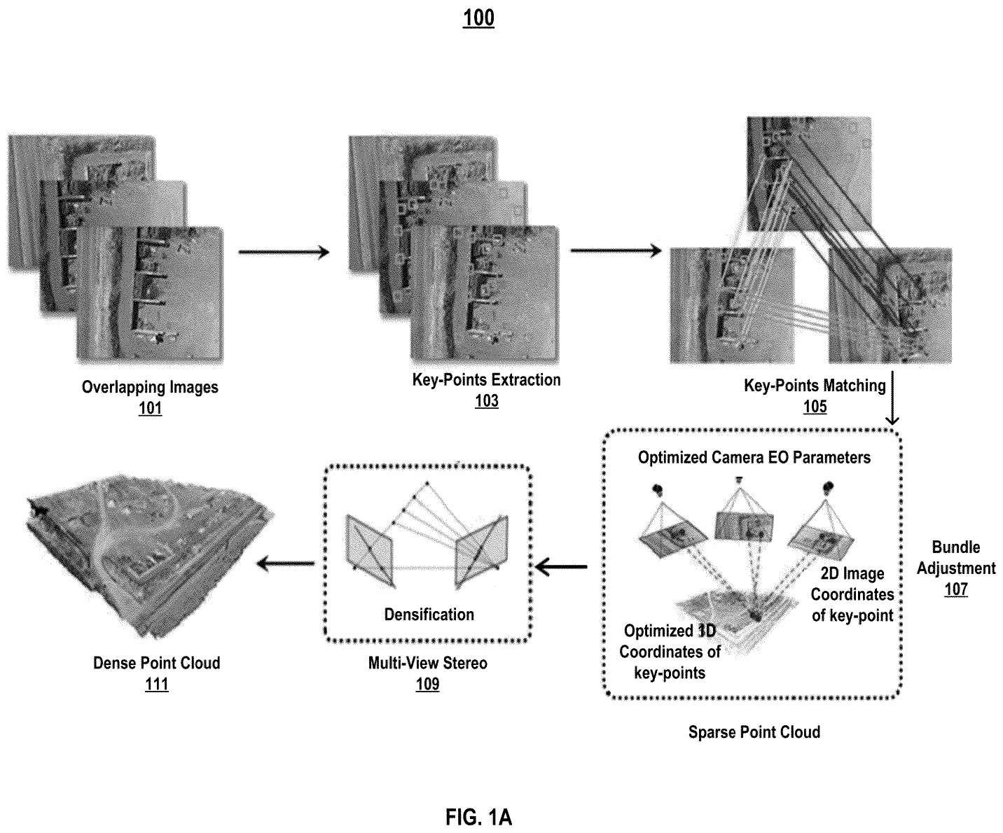

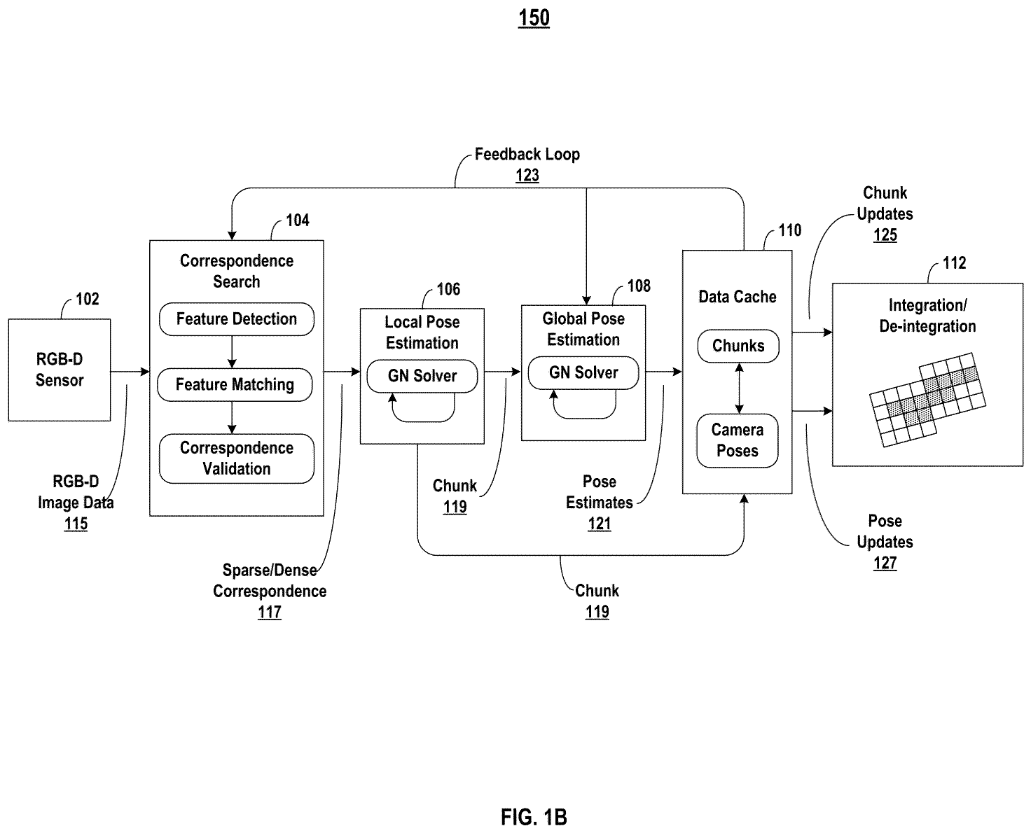

Structure-from-motion (SfM) and multi-view stereo (MVS) are two multi-view geometry reconstruction techniques used to recover the spatial structure of objects. SfM is a method that uses feature points in multiple unordered images to reconstruct camera motion trajectories and estimate camera parameters to generate sparse 3D-point clouds. To that end, the SfM pipeline extracts and matches local features between images, such as with the use of scale-invariant feature transform (SIFT). The SfM pipeline may then perform sparse point-cloud triangulation incrementally or globally. However, the sparse feature point distribution used by the SfM algorithm makes it difficult to recover low-level details. In complex scenes, errors in feature matching and reconstruction may occur, which means further post-processing and optimization is needed. This post-processing and optimization may be performed using the Multi-View Stereo (MVS) method. For instance, MVS relies on matching point clouds in multiple images to achieve high-density 3D reconstruction. To that end, MVS finds the corresponding points of each pixel in 3D space, which it then uses to obtain additional 3D information through dense matching. Then, MVS interpolates and optimizes the sparse point cloud in SfM to generate a more accurate and complete 3D model. The example operations of the MVS method are depicted in FIG. 1A.

For example, FIG. 1A illustrates a flow diagram of an example structure 100 for motion and MVS reconstruction. MVS reconstruction may begin by collecting a series of overlapping images 101 (e.g., images with overlapping parts) using the same or different perspectives or camera sensors. Then, key-points of extraction 103, which are the meaningful feature points in each image, are detected. Key-points matching 105 may then be performed. During key-points matching 105, the key-points or features-of-interest in the overlapping images 101 are matched in different images to calculate their correspondences. Next, bundle adjustment 107 may be performed to optimize the camera parameters and the positions of points in the scene. This normalizes the images from multiple perspectives and improves the matching accuracy. The matched key-points may be converted into points in three-dimensional space to form a sparse point cloud, which achieves an MVS 109. Finally, using the image information from multiple perspectives and interpolation methods, the missing parts of the original point cloud are filled in to generate a dense point cloud 111.

In practical applications, SfM and MVS can be seen as mutually cooperative. For instance, SfM provides camera poses and 3D point clouds, while MVS generates more accurate and complete 3D models based on the information generated by SfM. However, SfM faces difficulties in dealing with non-rigid scenes and image noise, while MVS has a high computational complexity problem in dealing with large-scale scenes.

This is because SfM and MVS are based on 2D image information, which results in incomplete and unrealistic 3D models. However, with the advent of depth cameras, depth-based 3D-scanning and reconstruction techniques have been developed. Common RGB-D sensors are now affordable and easy to use, making it easier for the development of new technologies. RGB-D 3D-reconstruction uses color images (RGB) and depth maps to reconstruct scenes. By processing and aligning color and depth images, this technology can accurately reconstruct scenes and objects in the real world to generate high-quality 3D models. Bundlefusion is a 3D-reconstruction algorithm based on RGB-D cameras that can perform globally consistent modeling in existing scenes. A flow diagram of an example Bundlefusion global-pose optimization 150 is illustrated in FIG. 1B.

Referring to FIG. 1B, Bundlefusion operations may begin by collecting RGB-D image sequences of an image area from multiple viewpoints using an RGB-D sensor 102. RGB-D sensor 102 may include a color sensor and a depth sensor (e.g., a Light Detection and Ranging (LiDAR) sensor). The RGB-D image sequences may be output as one or more RGB-D image data 115. For example, RGB-D image data 115 may include a color frame (e.g., color image data) and a depth frame (e.g., a depth map of objects in the frame). Then, a correspondence search component 104 may apply a depth-based feature extraction algorithm to extract feature points from the RGB-D image data 115. An indication of the feature points may be sent as a sparse/dense correspondence signal 117 to local-pose estimation component 106. Local-pose estimation component 106 may use a local geometric descriptor-based feature matching algorithm to match the extracted feature points from sparse/dense correspondence signal 117. These extracted feature points may be indicated as a chunk 119. Global-pose estimation component 108 may use a surface reconstruction algorithm that continuously merges new point sets into the image area based on the geometric information in the point cloud to generate pose estimates 121. Chunk 119 and pose estimates 121 may be maintained in a data cache 110. Data cache 110 may send chunk 119, pose estimations, chunk update(s) 125, or pose update(s) 127 to correspondence search component 104 in a feedback loop 123. Chunk update(s) 125 and pose updates 127 may be sent to an integration/de-integration component 112. Integration/de-integration component 112 may apply an optimization framework-based method to jointly optimize the point clouds from all viewpoints to obtain a globally consistent 3D representation of the image area.

However, traditional 3D-reconstruction methods and RGB-D camera-based 3D-reconstruction methods suffer from various drawbacks. For instance, these techniques require multiple-view image data and complex camera calibration, synchronization, view matching, and pose estimation steps. This results in a high-degree of algorithmic complexity. Unfortunately, the computational complexity of hardware devices is too high to meet the real-time requirement or only single-view depth image data can be provided instead of multiple views. This is especially true in mobile device, which have strict requirements on power consumption.

Thus, there is an unmet need for a 3D-reconstruction method that can significantly reduce computational and storage costs to enhance its practicality and feasibility for implementation in mobile devices.

To overcome these and other challenges, the present disclosure provides an exemplary 3D-reconstruction technique in which single-view color and depth data is used for 3D reconstruction. Based on the high-precision depth information provided by a single depth image, the geometric shape and details of an object may be reconstructed so that errors and inconsistency between multiple images may be avoided. In addition, since only a single image pair (e.g., color image data and depth data) is processed, the present technique avoids the computational complexity involved in matching and merging multiple images. This allows for a greater focus on depth information processing and precision enhancement to obtain accurate reconstruction results. Thus, although single-view depth image reconstruction has some limitations in terms of depth-estimation errors and view constraints, it is still effective in 3D reconstruction. To that end, the present disclosure provides an exemplary network architecture for depth completion to restore a dense-depth map from a sparse-depth map guided by the RGB attribute data.

In some embodiments, the exemplary network architecture described herein may include an exemplary sparse-depth completion network. In the exemplary sparse-depth completion network, two decoders are included in the color branch to exploit the inter-pixel relationships while extracting depth features. The first decoder of the color branch predicts a depth map for fusion, while the second decoder may be used to extract adaptive features for multi-scale fusion.

Moreover, the exemplary sparse-depth completion network may combine CSPN operations with guided filtering to fuse features from the two modalities (e.g., color and depth) at the decoder-encoder stage of the depth branch. To further refine the depth map, the exemplary sparse-depth completion network may fuse multi-modal features based on multi-affinity matrices, which are used to iteratively update the depth map until a refined dense-depth map is achieved.

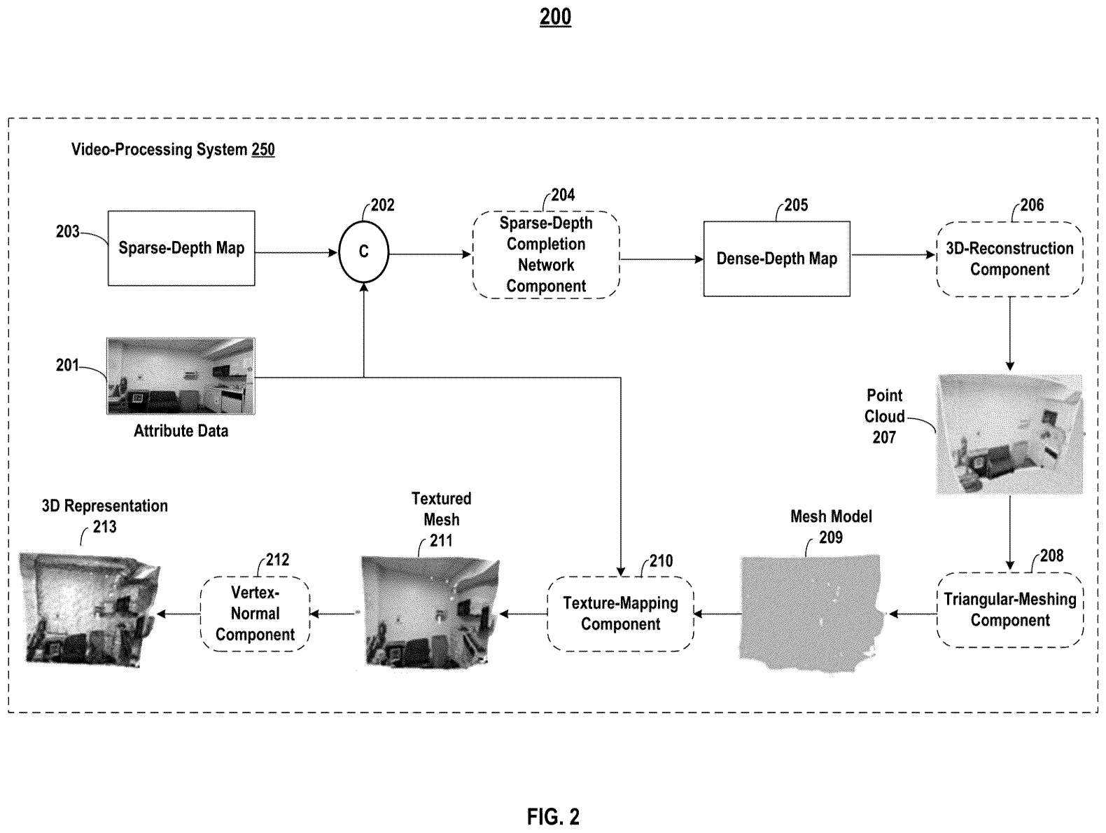

3D reconstruction may then be performed using the refined dense-depth map to obtain the optimal balance between depth sparsity and completion accuracy. Since the number of valid points in the depth map is reduced by the optimal depth sparsity, the exemplary network architecture described below can remarkably save power in mobile devices. Moreover, the exemplary network architecture may use the camera pinhole model to reconstruct the depth map into a point cloud, and then perform triangulation and mesh rendering to obtain a realistic 3D reconstruction of the image area. Additional details of the exemplary 3D-reconstruction network architecture and its exemplary operations are provided below in connection with FIGS. 2-10.

FIG. 2 illustrates a flow diagram 200 for generating a single-view 3D scene using an exemplary video-processing system 250 (referred to hereinafter as “video-processing system 250”), according to some embodiments of the present disclosure. Video-processing system 250 may include, e.g., a concatenator 202, a sparse-depth completion network component 204, a 3D-reconstruction component 206, a triangular-meshing component 208, a texture-mapping component 210, and a vertex-normal component 212.

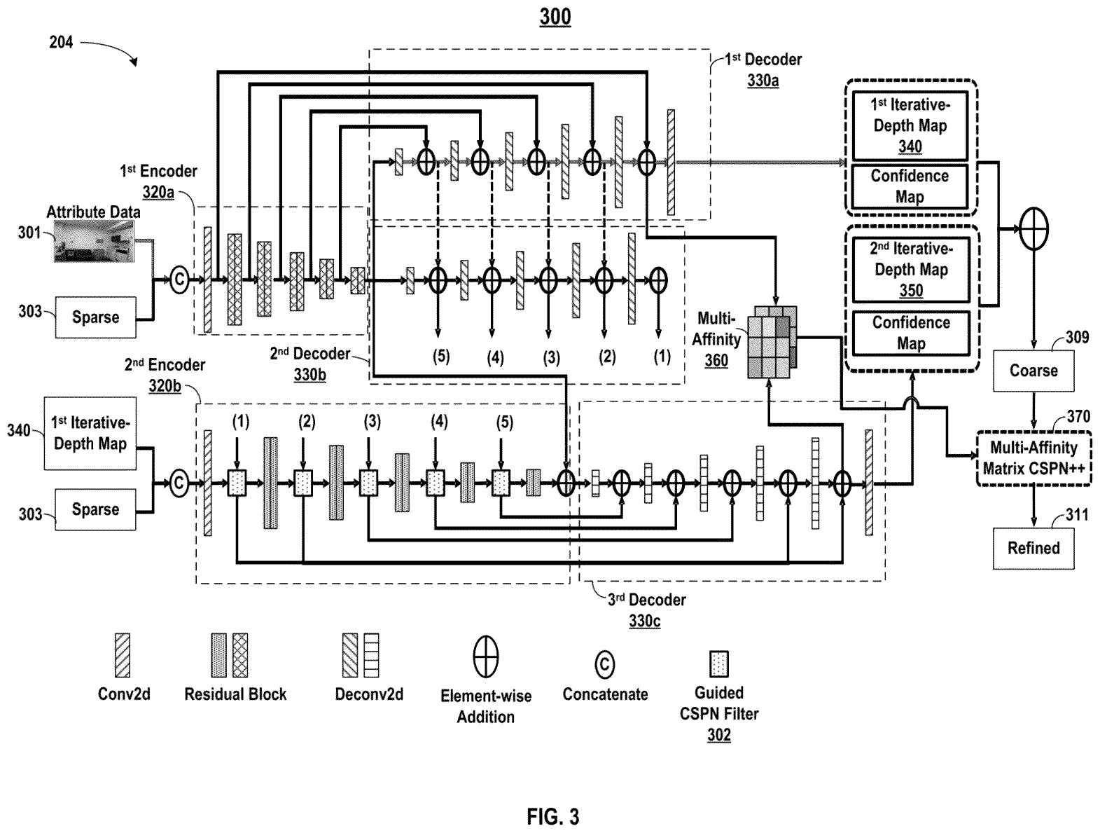

To begin, video-processing system 250 may receive attribute data 201 (e.g., color data, RGB data, reflectance data, intensity data, etc.) and a sparse-depth map 203 (also referred to herein as “depth data”). In In some implementations, the image area may be associated with a picture, a sub-picture, a tile, a slice, or a coding block. Attribute data 201 and sparse-depth map 203 may be concatenated (e.g., a pixel-wise concatenation) by concatenator 202. Sparse-depth completion network component 204 may perform an RGB-guided depth-completion process to generate iterative sparse-depth map(s), which are updated using multi-affinity matrices until a refined dense-depth map is obtained. Using the refined dense-depth map 205, 3D-reconstruction component 206 may generate a point cloud 207 (e.g., a 3D reconstruction) of the 2D image area. Triangular-meshing component 208 may perform triangular meshing of point cloud 207 to generate mesh model 209. Next, texture-mapping component 210 may apply mesh model 209 to attribute data 201 to generate a textured mesh 211 of the image area. Finally, vertex-normal component 212 may apply a vertex-normal algorithm to textured mesh 211 to generate a 3D representation 213 of the 2D image area. Additional details of the exemplary operations performed by video-processing system 250 are provided below in connection with FIGS. 3-10.

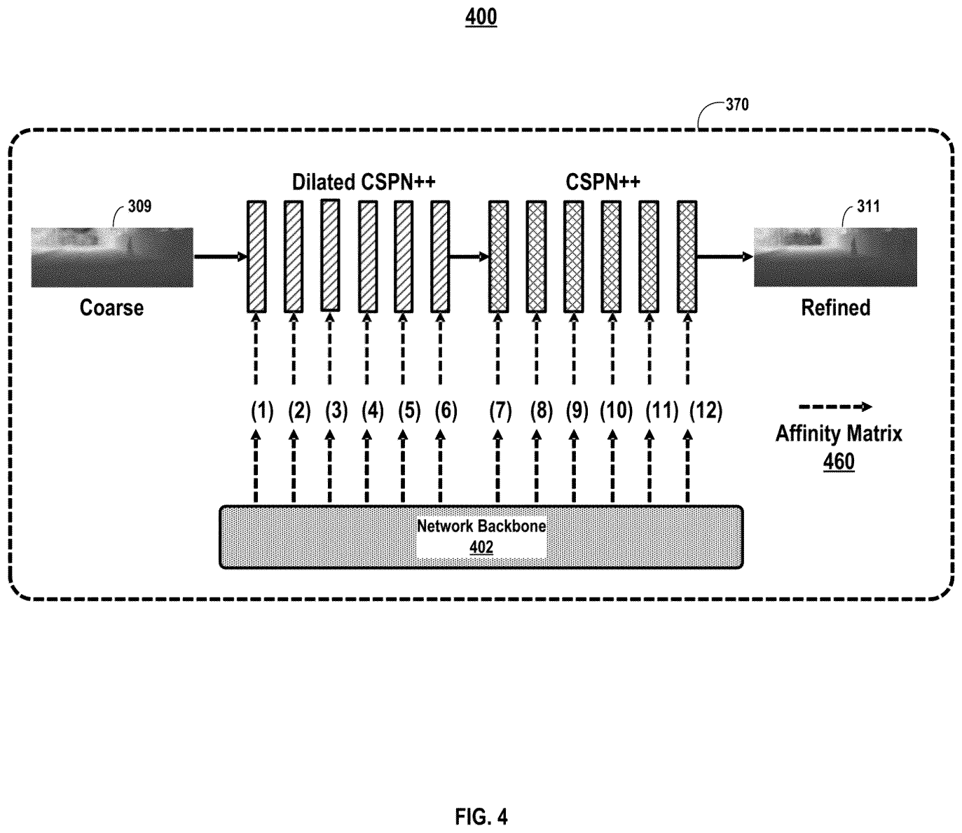

FIG. 3 illustrates a detailed diagram of an exemplary network architecture 300 of sparse-depth completion network component 204 of FIG. 2, according to some embodiments of the present disclosure. FIG. 4 illustrates a detailed diagram 400 of an exemplary multi-affinity matrix CSPN++ component 370 used by sparse-depth completion network component 204 of FIG. 3, according to some embodiments of the present disclosure. FIGS. 3 and 4 will be described together.

Due to the influence of factors such as equipment or surrounding environment, the depth value obtained by the depth sensor is sparse in two-dimensional space. This level of sparsity cannot meet the requirement of recovering rich three-dimensional structure information. For instance, if such depth maps, in which a large amount of missing depth information are directly used for 3D reconstruction, the visual effect of the surface of the generated 3D point cloud model is noticeably incomplete. Therefore, network architecture 300 is designed to recover a refined dense-depth map 311 from the sparse-depth map 303 under the guidance of the attribute data 301, as shown in FIG. 3.

Referring to FIG. 3, different from most parallel dual-branch networks, sparse-depth completion network component 204 includes two decoders (e.g., first decoder 330a and second decoder 330b) in the RGB decoder stage to predict more adaptive features after processing by encoders 320. At this time, sparse-depth completion network component 204 may make use of the complementarity of the iterative-depth maps predicted by the color branch and the depth branch concurrently, while avoiding the influence of color-branch supervision on the fusion of different modes in the decoder-encoder fusion stage.

The color stage may include, e.g., first encoder 320a, first decoder 330a, and second decoder 330b, while the depth stage may include second encoder 320b and third decoder 330c, attribute data 301 and a sparse-depth map 303 (e.g., captured by an RGB-D sensor or an RGB sensor and a LiDAR sensor) may be input into first encoder 320a. First decoder 330a may generate a first iterative-depth map 340 (and a confidence map) and a multi-affinity matrix 360 based on inputs to the RGB stage. On the other hand, second decoder 330b may be configured to generate a plurality of adaptive features (e.g., (1)-(5)) after each decoder stage. Each of the adaptive features may indicate different inter-pixel relationships between pixels in sparse-depth map 303.

Sparse-depth map 303, first iterative-depth map 340 (generated by first decoder 330a), and the plurality of adaptive features (generated by second decoder 330b) may be the inputs to the depth branch. Using the plurality of adaptive features, the sparse-depth completion network component 204 may fully exploit the inter-pixel relationships in the color branch to extract additional depth features. To further fuse of two different modal features (color and depth), each of the plurality of adaptive features is input into different guided CSPN filters 302 of second encoder 320b. Third decoder 330c may generate a second iterative-depth map 350 (and a confidence map) based on sparse-depth map 303, first iterative-depth map 340, and the plurality of adaptive features. By an element-wise addition of features from first iterative-depth map 340 and second iterative-depth map 350, a coarse-depth map 309 may be generated.

Guided CSPN filter component 302 (e.g., a fusion module) combines a CSPN with guided filtering to fuse features captured by the color branch and the depth branch. For instance, guided CSPN filters 302 may predict dynamic changes in the convolution kernel from the color branch, and then use these changes to extract deep features in different fusion stages according to expression (1).

$${\tilde{D}}_{u , v} = {Ψ}_{u , v} ( 0 , 0 ) ⊙ {D}_{u , v} + {\sum }_{i , j = - M}^{M} {Ψ}_{u , v} ( i , j ) ⊙ {D}_{u - i , v - j} , \qquad ( 1 )$$

where M=(k−1)/2, k determines the neighborhood range of the pixel, i, j≠0 and ψ_{u,v}( ) is calculated as according to expressions (2) and (3).

$${Ψ}_{u , v} ( i , j ) = \frac{{\tilde{Ψ}}_{u , v} ( i , j )}{{\sum }_{i , j , i , j \neq 0} \vert {\tilde{Ψ}}_{u , v} ( i , j ) \vert} ; and \qquad ( 2 )$$

$${Ψ}_{u , v} ( 0 , 0 ) = 1 - {\sum }_{i , j , i , j \neq 0} {Ψ}_{u , v} ( i , j ) , \qquad ( 3 )$$

where ψ̅_{u,v} (i, j) is the affinity matrix, and ψ_{u,v}(i, j) is the normalized result to ensure the stability of guided CSPN filter component 302.

To avoid over-smoothing refined dense-depth map 311 after multiple iterations, multi-affinity matrix CSPN++ component 370 may apply different affinity matrices to update coarse-depth map 309. The multi-affinity matrices 360 may assign different inter-pixel weights associated with its adaptive features. This makes the pixel values of the refined dense-depth map 311 more accurate after each iteration.

Referring to FIG. 4, multi-affinity matrices may be adaptively generated from high-level features at the end of the network architecture backbone 402 via the convolutional layers. When refining coarse-depth map 309, each of the affinity matrix 460 may be used to iteratively update the pixels at the same spatial location. Since the weights of a multi-affinity matrix consider inter-pixel relationships, multi-affinity matrix avoids over-smoothing. This may increase the clarity and structural details in refined dense-depth map 311. Finally, the depth values are refined by distant pixels using a dilated convolution with an increased respective field. Refined dense-depth map 311 generated based on multi-affinity matrix 460 may be described according to expression (4).

$${D}_{i + 1} = {Φ}_{CSPN ++} ( {A}_{i} ; {D}_{i} ) , \qquad ( 4 )$$

where Φ_{CSPN++} is CSPN++ function, Dᵢ and Dᵢ₊₁ are the respective depth maps before and after updating, respectively, and Aᵢ represents multi-affinity matrix of iteration index i. Additional details of the exemplary 3D-reconstruction procedure performed after sparse-depth completion network component 204 are provided below.

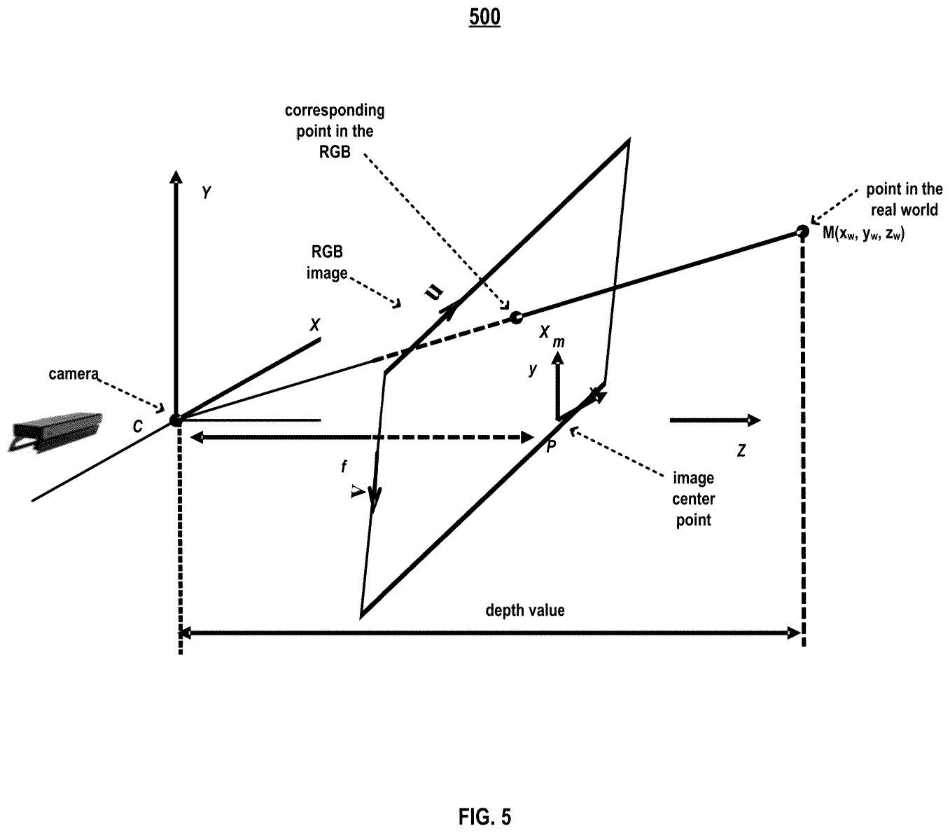

For instance, FIG. 5 illustrates a diagram of an exemplary camera projection pinhole model 500 applied by 3D-reconstruction component 206 of FIG. 2, according to some embodiments of the present disclosure. With the expansion of the mobile device market, more and more consumers are interested in experiencing 3D scenes on mobile devices. Time-of-flight (ToF) stereo-depth sensing lenses are emerging 3D-imaging technology that detects and analyzes object distance, shape, and motion with high-precision. This may provide a more realistic and immersive experience. Using depth cameras for 3D reconstruction faces challenges, however, and requires special optimization and control for power-sensitive mobile devices to ensure device stability and battery lifespan. At the same time, the power consumption and battery life limit the application of depth cameras. Therefore, when using ToF sensors for 3D reconstruction on mobile devices, an appropriate tradeoff between power consumption and performance is needed.

To make depth cameras more suitable for mobile devices, some measures may be taken to reduce power consumption. For example, in the field of augmented reality (AR), low-power consumption and long-distance have become important technical indicators. In contrast, the sparsity requirement of depth-pixel values may be less stringent. Therefore, video-processing system 250 may train sparse depth maps (e.g., iteratively update coarse-depth map 309 until refined dense-depth map 311 is achieved) to effectively reduce the power consumption requirements of depth cameras. Sparsity may refer to retaining less depth information in the depth map, thereby reducing computational complexity and storage requirements. When designing a depth camera, it is necessary to find a balance between ensuring the accuracy and stability of 3D reconstruction and minimizing power consumption as much as possible. To that end, video-processing system 250 may train and test depth maps with different sparsities to find ideal sparsity thresholds and algorithm parameters. By determining the ideal sparsity, the power consumption of the depth camera may be reduced while maintaining performance, which renders depth cameras more suitable for use in mobile devices.

Still referring to FIG. 5, unlike outdoor scenes, indoor scenes often require close-range image capture within a confined space, such as in an office or bedroom. In the real world, cameras capture images based on the pinhole model, which means that the camera maps coordinate in 3D space onto the image plane. This mapping process may be performed by 3D-reconstruction component 206, which is illustrated in FIG. 5. For instance, 3D-reconstruction component 206 may assign each pixel point on the image plane to a corresponding point in 3D space. This process can be represented by expression (7).

$${z}_{c} ( \begin{matrix}u \\ v \\ 1\end{matrix} ) = [ \begin{matrix}f / dx & 0 & {u}_{0} \\ 0 & f / dy & {v}_{0} \\ 0 & 0 & 1\end{matrix} ] \begin{matrix}[ R & T ] [ \begin{matrix}{x}_{w} \\ {y}_{w} \\ {z}_{c} \\ 1\end{matrix} ] ,\end{matrix} \qquad ( 5 )$$

where ƒ/dx, ƒ/dy, u₀, v₀ are the camera intrinsic parameters, R, T is the camera extrinsic parameters, u, v are the coordinates of a point on the two-dimensional plane, x_{w}, y_{w}, z_{c} are the corresponding 3D space points.

Since video-processing system 250 reconstructs a 3D scene (e.g., generates point cloud 207) from a single-view, 3D-reconstruction component 206 may be designed to consider camera coordinates and world coordinates together. Therefore, R and T form the matrix illustrated as expression (6).

$$R , T = [ \begin{matrix}1 & 0 & 0 \\ 0 & 1 & 0 \\ 0 & 0 & 1\end{matrix} ] , [ \begin{matrix}0 \\ 0 \\ 0\end{matrix} ] . \qquad ( 6 )$$

By combining depth and positional information, 3D-resconstruction component 206 may leverage their relationship to transform refined dense-depth map 205 into point cloud 207 (e.g., a 3D point cloud scene) according to expressions (7)-(9).

$${x}_{w} = {z}_{c} \cdot ( u - {u}_{0} ) \cdot dx / f ; \qquad ( 7 )$$

$${y}_{w} = {z}_{c} \cdot ( v - {v}_{0} ) \cdot dy / f ; and \qquad ( 8 )$$

$${z}_{w} = {z}_{c} . \qquad ( 9 )$$

Referring back to FIG. 2, triangular-meshing component 208 may generate a smooth and continuous representation (e.g., mesh model 209) of a surface for further processing and analysis. Triangle meshing is a technique of representing surfaces using a mesh composed of many triangles. In Open 3D, the alpha shape is a 3D surface-reconstruction method based on point clouds that can convert discrete point cloud data into a continuous 3D surface model (e.g., mesh model 209). This method uses an alpha parameter value to construct a series of nested surfaces, where the alpha parameter is considered as a distance threshold for constructing surfaces. These operations performed by triangular-meshing component 208 are summarized below as “Algorithm 1.”

In general, the goal of the alpha shape method is to find nested triangular faces that form the edges of the alpha complex. As the alpha parameter value increases, the number of edges in the alpha complex increases, while the number of triangular faces decreases. Therefore, the alpha parameter value can control the smoothness and level of detail of the mesh model 209. When using this method for surface reconstruction, triangular-meshing component 208 may apply an appropriate alpha parameter value to obtain the optimal result (e.g., mesh model 209).

Algorithm 1 Alpha Shape

Input: Point clouds S^{n×3}, where sᵢ(xᵢ, [symbol] ᵢ, zᵢ) ∈ S, alpha value α.
Output: Boundary triangle index sets M^{m×3}, mⱼ(sₐ, s_{b}, s_{c}) ∈ M.

| | |
|---|---|
| 1: | Calculate the Euclidean distance D between each point in S. |
| 2: | Construct an alpha complex. |
| 3: | for D do |
| 4: | if D ≤ 2 × α then |
| 5: | Connect them with lines or curves. |
| 6: | end if |
| 7: | end for |
| 8: | Perform a Delaunay triangulation on the alpha complex to obtain a |
| | triangular mesh T. |
| 9: | for Each triangle tᵢ ∈ T do |
| 10: | if The triangle tᵢ is contained within a larger triangle then |
| 11: | Remove this triangular tᵢ. |
| 12: | end if |
| 13: | end for |
| 14: | return M is built using the remaining T. |

Referring again to FIG. 2, texture-mapping component 210 maps 2D images (e.g., attribute data 201) onto the surface of 3D objects (e.g., mesh model 209), thereby enhancing the realism of the object. This technique not only increases the level of detail and color characteristics of the object's surface but also improves the rendering effect. The texture-mapping operations performed by texture-mapping component 210 are shown below in “Algorithm 2.” In practical applications, texture-mapping technology may add more details and patterns to the surface of three-dimensional objects, thereby providing more realistic visual effects for various scenes. At the same time, vertex-normal component 212 may use vertex normals, which are the normal vectors at each vertex in textured mesh 211. The vertex normals may be obtained by calculating the average of the normal vectors of the faces around each vertex. The vertex normal can be used to calculate lighting effects to determine the intensity and color of light at each vertex. To ensure the quality of three-dimensional graphics rendering, vertex-normal component 212 may apply vertex normals to textured mesh 211 to generate 3D representation 213.

Algorithm 2 Texture Mapping

Input: Triangle mesh M, texture image I^{h×w}.
Output: Triangle mesh M′ with texture mapping.

| | |
|---|---|
| 1: | for each triangle m ∈ M do |
| 2: | for each vertex v(x, [symbol] , z) ∈ m do |
| 3: | Use (x, [symbol] ) in vertex v as its texture coordinate uv. |
| 4: | end for |
| 5: | end for |
| 6: | Normalize uv to [0, 1] to obtain uvₙₒᵣₘₐₗ. |
| 7: | Invert and add one to the v-coordinate of uvₙₒᵣₘₐₗ to obtain uvₙₒᵣₘₐₗ′. |
| 8: | for each triangle m ∈ M do |
| 9: | Use interpolation algorithm to calculate the texture coordinate of any point |
| | based on uvₙₒᵣₘₐₗ′ of (v₁, v₂, and v₃) ∈ m. |
| 10: | Multiply the texture coordinate by h and w to obtain the texture image coor- |
| | dinate pᵤᵥ. |
| 11: | Get the corresponding color value of the pixel from the texture image based |
| | on pᵤᵥ. |
| 12: | end for |
| 13: | return M′ |

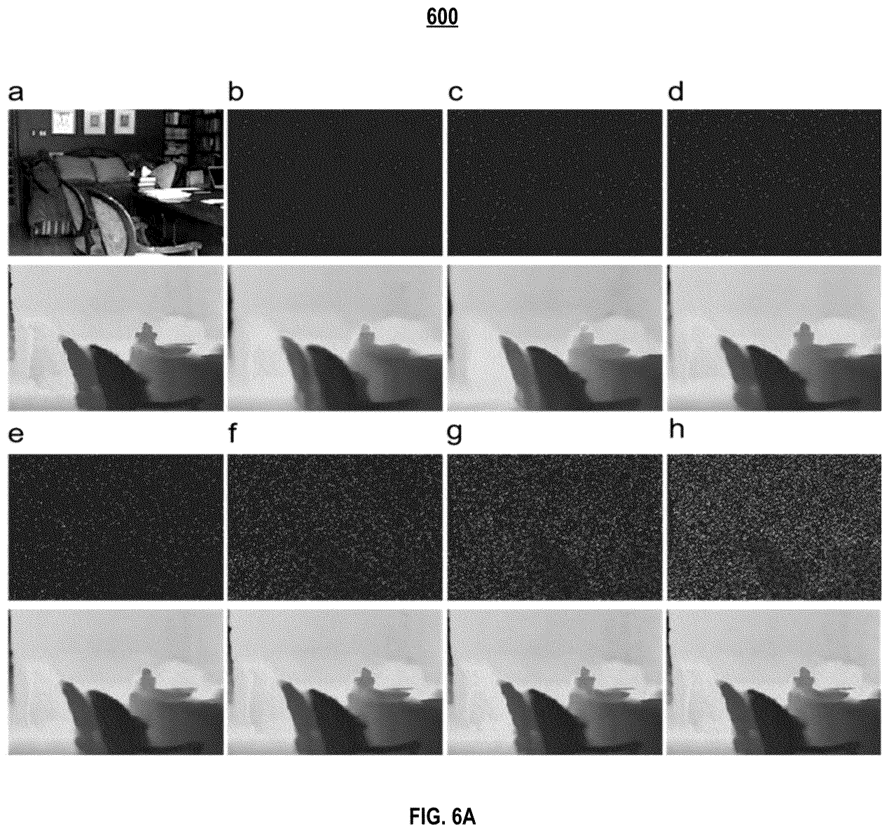

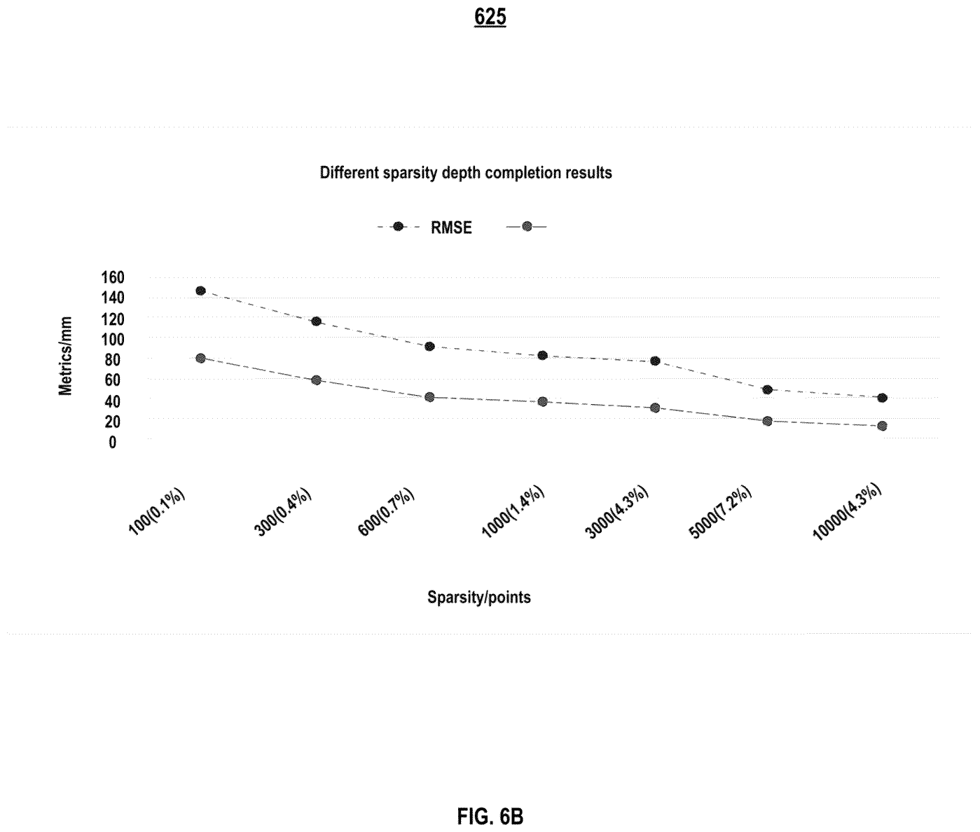

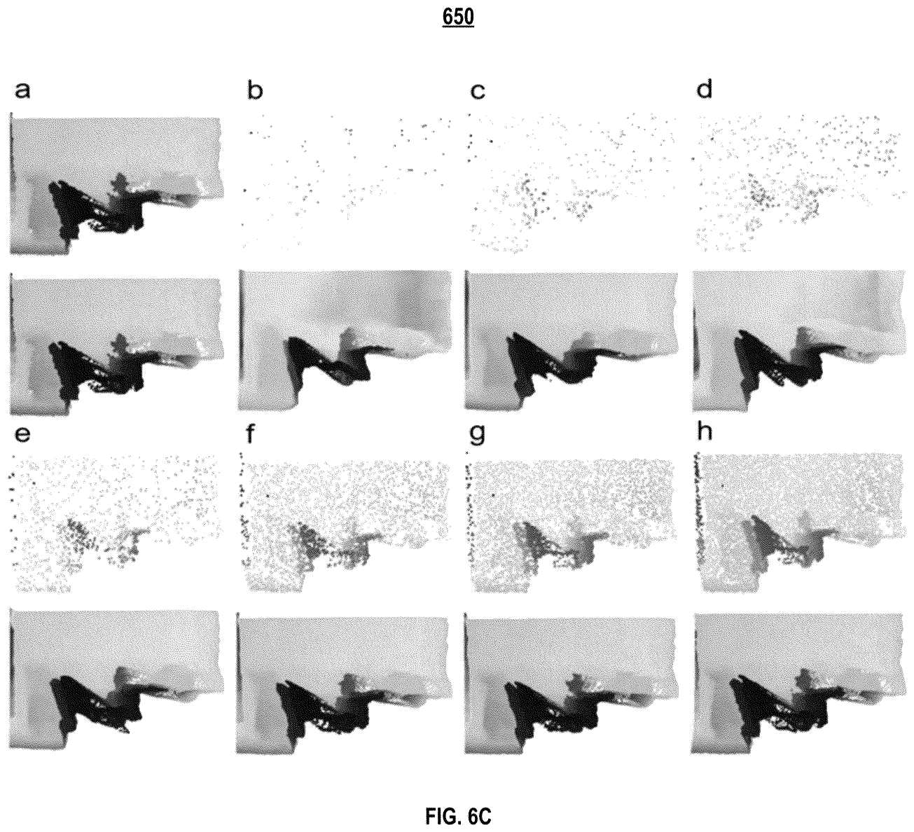

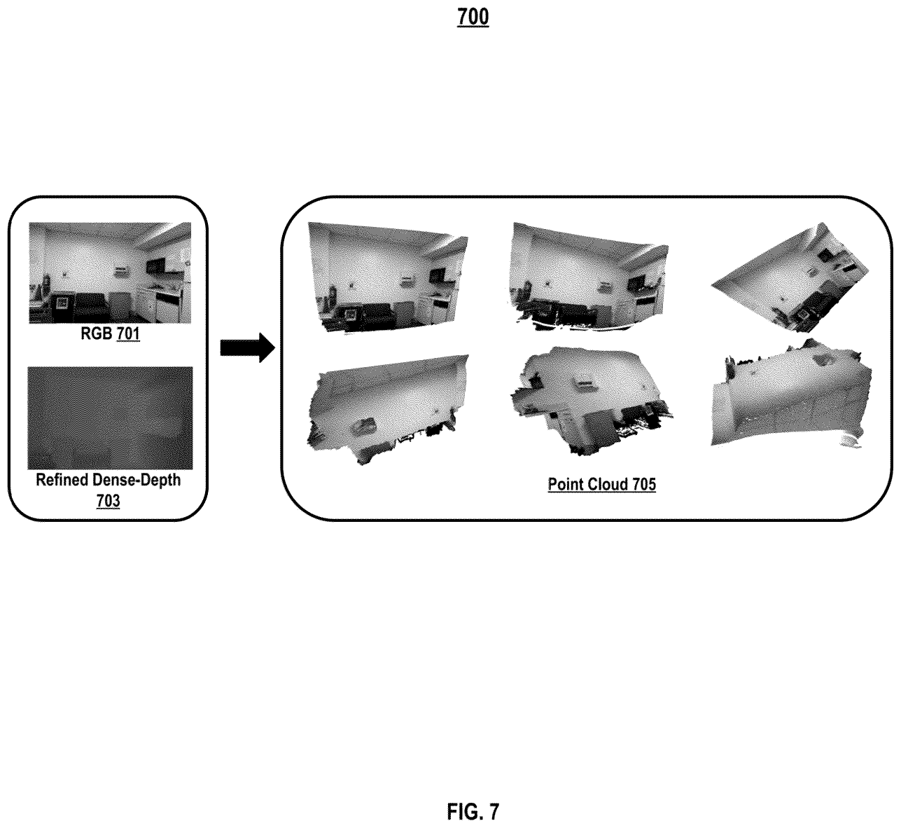

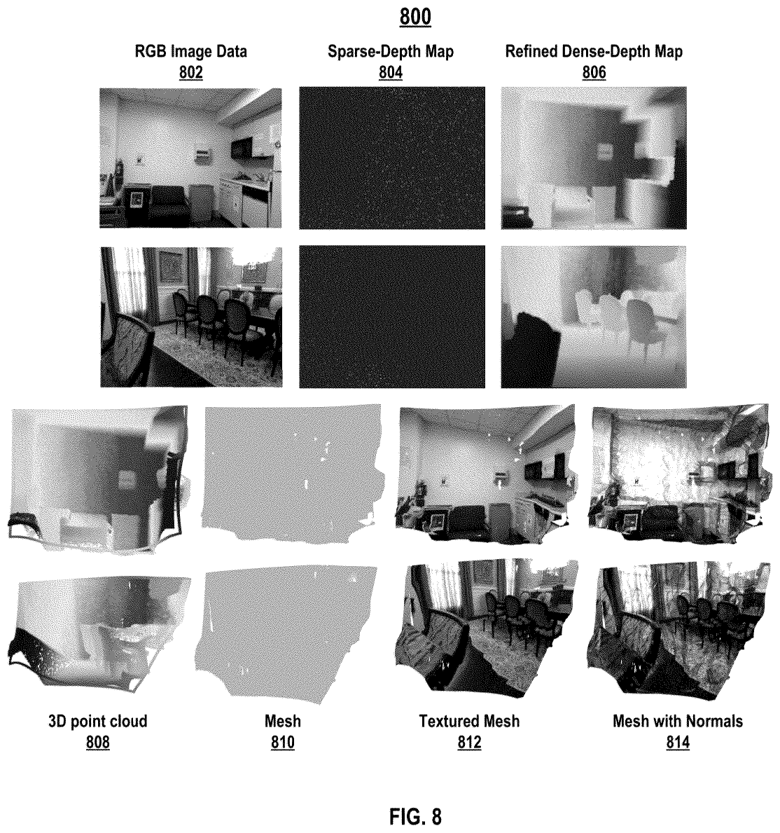

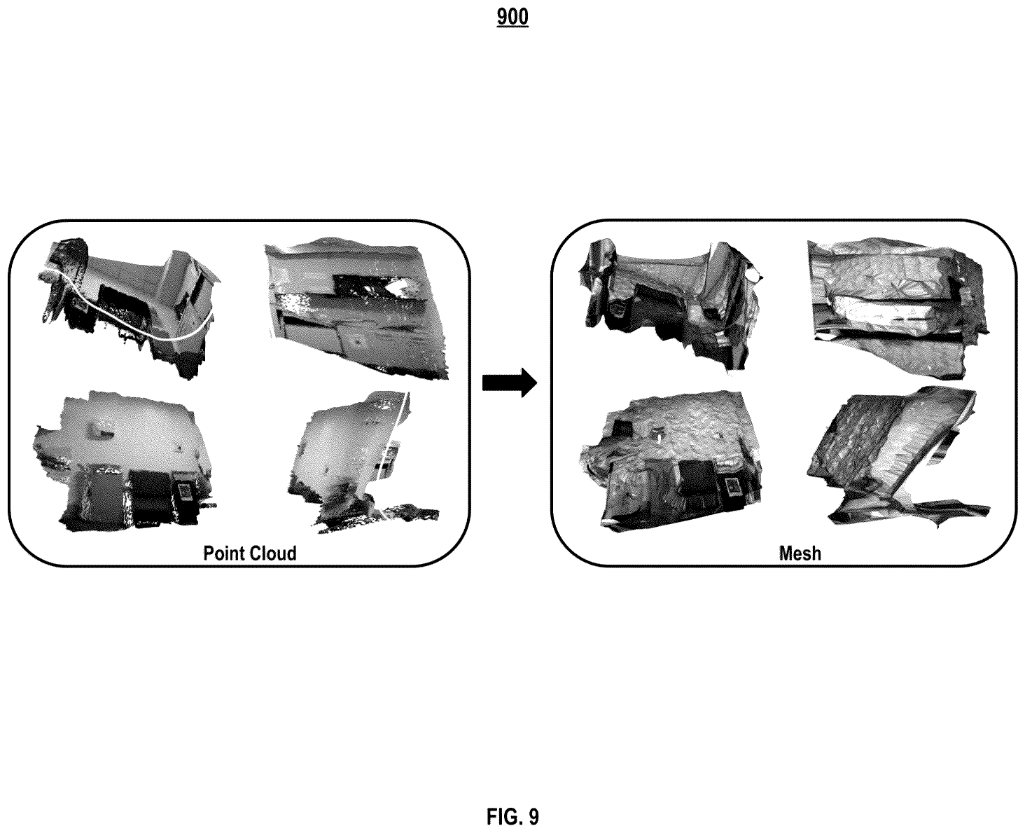

FIG. 6A illustrates a diagram representing a visual comparison 600 of sparse-depth completion performed using the exemplary network architecture 300 of FIG. 3, according to some embodiments of the present disclosure. FIG. 6B illustrates a graphical representation 625 of RMSE and MAE performance according to depth sparsity, according to some embodiments of the present disclosure. FIG. 6C illustrates a diagram representing visual comparison 650 of a 3D point-cloud scene from different depth sparsities, according to some embodiments of the present disclosure. FIG. 7 illustrates a diagram 700 of a point cloud 705 generated from a single RGB-D image (e.g., attribute data 701 and refined dense-depth map 703) generated using the exemplary network architecture of FIG. 3, according to some embodiments of the present disclosure. FIG. 8 illustrates a diagram 800 of reconstructed point-clouds and 3D mesh-structures from a single RGB-D image generated by the exemplary network architecture of FIG. 3, according to some embodiments of the present disclosure. FIG. 9 illustrates a diagram of a visual comparison 900 of reconstructed results from different perspectives between a point cloud and mesh model generated by the exemplary network architecture of FIG. 3, according to some embodiments of the present disclosure.

Referring to FIG. 6A, the accuracy of video-processing system 250 was tested using root mean square error (RMSE) and mean absolute error (MAE) as evaluation metrics to select the optimal depth sparsity for 3D reconstruction. As the depth sparsity increases, the visible surfaces in the completed dense depth map become clearer. This result indicates that video-processing system 250 is capable of handling sparse-depth data of different degrees with improved performance. This is beneficial for 3D-reconstruction tasks that may encounter depth data of various densities ranging from extremely dense to extremely sparse. Therefore, video-processing system 250 exhibits robustness and versatility under different scenarios.

Referring to FIG. 6B, to maintain performance while reducing power consumption in the process of 3D reconstruction, 3D-reconstruction component 206 applies the optimal threshold for indoor-scene depth-completion to address the issue of depth sparsity. Therefore, a quantitative measurement of sparse-depth completion based on depth sparsity data was performed, the results of which are summarized below in Table 1. These results indicate that there is a positive correlation between depth sparsity and the accuracy of the depth map. This means that the higher the depth sparsity, the more accurate the completed depth map. In the case of a depth sparsity of 300 (0.7%), the RMSE value obtained is less than 100 mm. This indicates that the exemplary depth-completion method implemented by video-processing system 250 can obtain a relatively accurate depth map under this level of depth sparsity.

TABLE 1
Quantitative measurements of sparse depth
completion according to depth sparsity

| Depth sparsity | RMSE (mm) | MAE (mm) |
|---|---|---|
| 100 points (0.1%) | 147.34 | 79.4 |
| 300 points (0.4%) | 115.3 | 57.8 |
| 500 points (0.7%) | 91.6 | 41.6 |
| 1000 points (1.4%) | 81.9 | 37.2 |
| 3000 points (4.3%) | 75.6 | 30.6 |
| 5000 points (7.2%) | 49.1 | 17.8 |
| 10000 points (14%) | 40.4 | 13.2 |

Referring to FIG. 6C, a visual comparison of sparse-depth completion performed by video-processing system 250 using different depth sparsities is shown. In (a), RGB image and its corresponding ground truth depth map are shown. In (b), a depth sparsity of 100 points (0.1%) is shown. In (c), a depth sparsity of 300 points (0.4%) is shown. In (d), a depth sparsity of 300 points (0.7%) is shown. In (e), a depth sparsity of 1000 points (1.4%) is shown. In (f), a depth sparsity of 3000 points (4.3%) is shown. In (g), a depth sparsity of 5000 points (7.2%) is shown. In (h), a depth sparsity of 10000 points (14%) is shown. The bottom of each image in FIG. 6C illustrates their completed depth map.

From the experimental results shown in FIG. 6B, it can be concluded that the depth sparsity has an impact on the RMSE and MAE performance. By observing the slopes in FIG. 6B, it can be shown that when the depth sparsity is low, the slope is relatively large. This indicates that the performance of video-processing system 250 may be sensitive to the depth sparsity. However, as the depth sparsity increases, the slope gradually decreases, which may indicate that the impact of depth sparsity on performance becomes smaller. This suggests that as the depth sparsity increases, the improvement in performance gradually diminishes, and there exists an optimal point for achieving the best performance. The 3D point clouds shown in FIG. 6C further support this conclusion.

For instance, referring to FIG. 6C, the reconstructed point cloud in (d) is clearer in detail than (b) and (c), but the increase in clarity in (e), (f), (g), and (h) is comparatively insignificant. Therefore, the depth sparsity of (d) (e.g., 500 points (0.7%)) achieves an optimal balance between reconstruction accuracy and power consumption for 3D reconstruction. These conclusions are highly valuable for practical applications as they can help reduce the power consumption of mobile devices.

Referring to FIG. 7, some 3D indoor point cloud reconstruction results (e.g., point cloud 705) from different viewpoints are shown. This illustrates that 3D-reconstruction component 206 may generate a point cloud 705 based on attribute data 701 and a refined dense-depth map 703 (generated by sparse-depth completion network component 204) with a high-degree of accuracy.

The proposed framework produces 3D-reconstruction results from a single RGB-D image (e.g., RGB image data 802 and sparse-depth map 804) in various scenes, as shown in FIG. 8. The proposed framework utilizes depth information captured by RGB-D cameras and sparse depth completion techniques to obtain 3D data of the scene. The Open 3D library may be used to process and analyze the data, generating multiple types of 3D structures, including point clouds and meshes. For example, based on refined dense-depth map 806 and RGB image data 802, a 3D point cloud 808, a mesh model 810, a textured mesh 812, and a 3D reconstruction 814 (e.g., a textured mesh with normals) may be generated. Meshes offer stronger expressive power and better visualization effects than point clouds because they can simulate and represent 3D surfaces in greater detail, as shown in FIG. 9. By performing point cloud reconstruction, surface reconstruction, and mesh rendering, realistic 3D-reconstruction models can be generated by video-processing system 250 to represent real scenes in virtual environments.

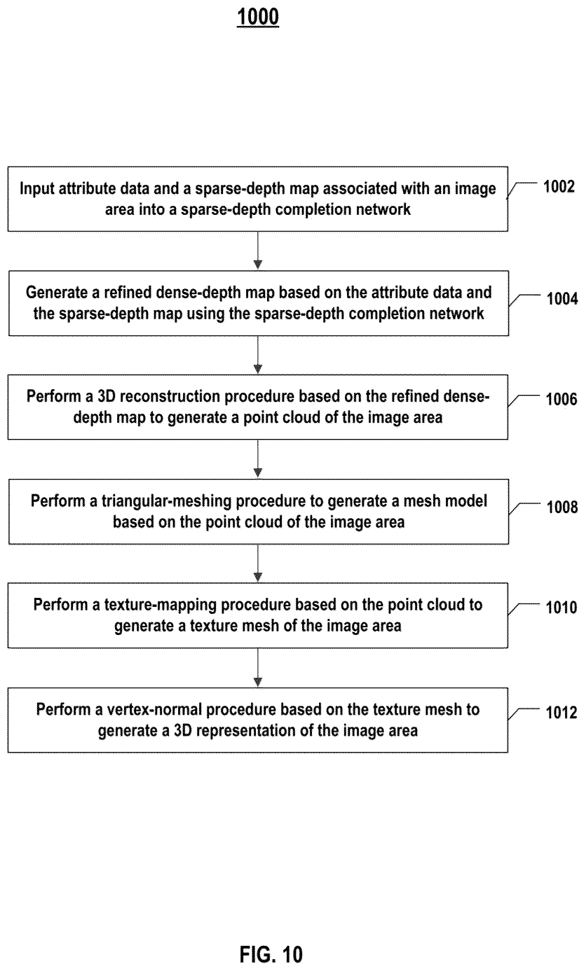

FIG. 10 illustrates a flowchart of an exemplary method 1000 of video processing, according to some embodiments of the present disclosure. Method 1000 may be performed by a system, e.g., such as video-processing system 250, sparse-depth completion network component 204, 3D-reconstruction component 206, triangular-meshing component 208, texture-mapping component 210, or vertex-normal component 212, just to name a few. Method 1000 may include operations 1002-1012, as described below. It is to be appreciated that some of the steps may be optional, and some of the steps may be performed simultaneously, or in a different order than shown in FIG. 10.

Referring to FIG. 10, at 1002, the system may input attribute data and a sparse-depth map associated with an image area into a sparse-depth completion network. For example, referring to FIG. 2, attribute data 201 (e.g., color data, RGB data, reflectance data, intensity data, etc.) and a sparse-depth map 203 (also referred to herein as “depth data”) of a 2D image area may be input into video-processing system 250.

At 1004, the system may generate a refined dense-depth map based on the attribute data and the sparse-depth map using the sparse-depth completion network. For example, referring to FIG. 3, different from most parallel dual-branch networks, sparse-depth completion network component 204 includes two decoders (e.g., first decoder 330a and second decoder 330b) in the RGB decoder stage to predict more adaptive features after processing by first encoder 320a. At this time, sparse-depth completion network component 204 may make use of the complementarity of the iterative-depth maps predicted by the color branch and the depth branch concurrently, while avoiding the influence of color-branch supervision on the fusion of different modes in the decoder-encoder fusion stage. The color stage may include, e.g., first encoder 320a, first decoder 330a, and second decoder 330b, while the depth stage may include second encoder 320b and third decoder 330c, attribute data 301 and a sparse-depth map 303 (e.g., captured by an RGB-D sensor or an RGB sensor and a LiDAR sensor) may be input into first encoder 320a. First decoder 330a may generate a first iterative-depth map 340 (and a confidence map) and a multi-affinity matrix 360 based on inputs to the RGB stage. On the other hand, second decoder 330b may be configured to generate a plurality of adaptive features (e.g., (1)-(5)) after each decoder stage. Each of the adaptive features may indicate different inter-pixel relationships between pixels in sparse-depth map 303. Sparse-depth map 303, first iterative-depth map 340 (generated by first decoder 330a), and the plurality of adaptive features (generated by second decoder 330b) may be the inputs to the depth branch. Using the plurality of adaptive features, the sparse-depth completion network component 204 may fully exploit the inter-pixel relationships in the color branch to extract additional depth features. To further refine the depth map, each of the plurality of adaptive features is input into different guided CSPN filters 302 of second encoder 320b. Third decoder 330c may generate a second iterative-depth map 350 (and a confidence map) based on sparse-depth map 303, first iterative-depth map 340, and the plurality of adaptive features. By an element-wise addition of features from first iterative-depth map 240 and second iterative-depth map 350, a coarse-depth map 309 may be generated. Guided CSPN filters 302 (e.g., a fusion module) combines a CSPN with guided filtering to fuse features captured by the color branch and the depth branch in different fusion stages according to expressions (1)-(3). For instance, guided CSPN filters 302 may predict dynamic changes in the convolution kernel from the color branch. To avoid over-smoothing refined dense-depth map 311 after multiple iterations, multi-affinity matrix CSPN++ component 370 may apply different affinity matrices to update coarse-depth map 309. Each of the multi-affinity matrices 360 may assign different inter-pixel weights associated with its adaptive features. This makes the pixel values of the refined dense-depth map 311 more accurate after each iteration. Referring to FIG. 4, multi-affinity matrix may be adaptively generated from high-level features at the end of the network architecture backbone 402 via the convolutional layers. When refining coarse-depth map 309, affinity matrix 460 may be used to iteratively update the pixels at the same spatial location. Since the weights of a multi-affinity matrix consider inter-pixel relationships, multi-affinity matrix avoid over-smoothing. This may increase the clarity and structural details in refined dense-depth map 311. Finally, the depth values are refined by distant pixels using a dilated convolution with an increased respective field. Refined dense-depth map 311 generated based on multi-affinity matrix may be described according to expression (4).

At 1006, the system may perform a 3D-reconstruction procedure based on the refined dense-depth map to generate a point cloud of the image area. For example, referring to FIG. 2, indoor scenes often require close-range image capture within a confined space, such as in an office or bedroom. In the real world, cameras capture images based on the pinhole model, which means that the camera maps coordinate in 3D space onto the image plane. This mapping process may be performed by 3D-reconstruction component 206. For instance, 3D-reconstruction component 206 may assign each pixel point on the image plane to a corresponding point in 3D space. This process can be represented by expression (7). Since video-processing system 250 reconstructs a 3D image area (e.g., generates point cloud 207) from a single-view, 3D-reconstruction component 206 may be designed to consider camera coordinates and world coordinates together. Therefore, R and T form the matrix illustrated as expression (6). By combining depth and positional information, 3D-resconstruction component 206 may leverage their relationship to transform refined dense-depth map 205 into point cloud 207 (e.g., a 3D point cloud scene) according to expressions (7)-(9).

At 1008, the system may perform a triangular-meshing procedure to generate a mesh model based on the point cloud of the image area. For example, referring to FIG. 2, triangular-meshing component 208 may generate a smooth and continuous representation (e.g., mesh model 209) of a surface for further processing and analysis. Triangle meshing is a technique of representing surfaces using a mesh composed of many triangles. In Open 3D, the alpha shape is a 3D surface-reconstruction method based on point clouds that can convert discrete point cloud data into a continuous 3D surface model (e.g., mesh model 209). This method uses an alpha parameter value to construct a series of nested surfaces, where the alpha parameter is considered as a distance threshold for constructing surfaces. These operations performed by triangular-meshing component 208 are summarized above as “Algorithm 1.” In general, the goal of the alpha shape method is to find nested triangular faces that form the edges of the alpha complex. As the alpha parameter value increases, the number of edges in the alpha complex increases while the number of triangular faces decreases. Therefore, the alpha parameter value can control the smoothness and level of detail of the mesh model 209. When using this method for surface reconstruction, triangular-meshing component 208 may apply an appropriate alpha parameter value to obtain the optimal result (e.g., mesh model 209).

At 1010, the system may perform a texture-mapping procedure based on the point cloud to generate a texture mesh of the image area. For example, referring to FIG. 2, texture-mapping component 210 maps 2D images (e.g., attribute data 201) onto the surface of 3D objects (e.g., mesh model 209), thereby enhancing the realism of the object. This technique not only increases the level of detail and color characteristics of the object's surface but also improves the rendering effect. The texture-mapping operations performed by texture-mapping component 210 are shown below in “Algorithm 2.” In practical applications, texture-mapping technology may add more details and patterns to the surface of three-dimensional objects, thereby providing more realistic visual effects for various scenes.

At 1012, the system may perform a vertex-normal procedure based on the textured mesh to generate a 3D representation of the image area. Referring to FIG. 2, vertex-normal component 212 may use vertex normals, which are the normal vectors at each vertex in textured mesh 211. The vertex normals may be obtained by calculating the average of the normal vectors of the faces around each vertex. The vertex normal can be used to calculate lighting effects to determine the intensity and color of light at each vertex. To ensure the quality of three-dimensional graphics rendering, vertex-normal component 212 may apply vertex normals to textured mesh 211 to generate 3D representation 213.

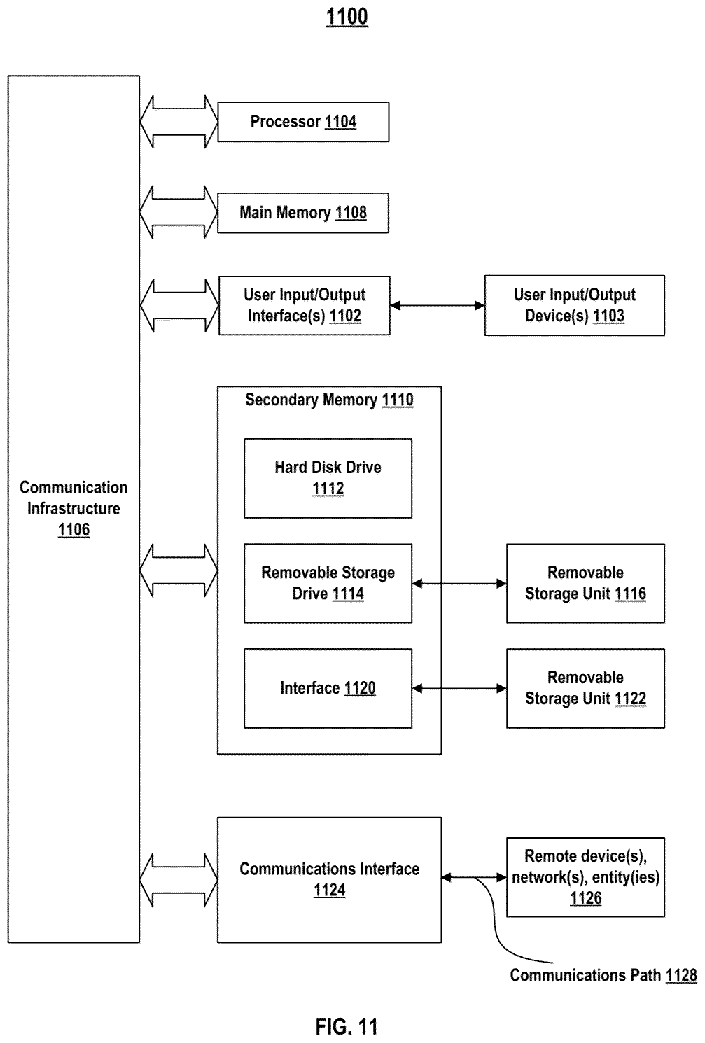

Various embodiments can be implemented, for example, using one or more computer systems, such as computer system 1100 shown in FIG. 11. One or more computer system 1100 can be used, for example, to implement method 1000 of FIG. 10. For example, computer system 1100 can generate an enhanced image based on first image data captured by a first image sensor using a first FOV and first resolution and second image data captured by a second image sensor using a second FOV and second resolution, according to various embodiments. Computer system 1100 can be any computer capable of performing the functions described herein.

Computer system 1100 can be any well-known computer capable of performing the functions described herein. Computer system 1100 includes one or more processors (also called central processing units, or CPUs), such as a processor 1104. Processor 1104 is connected to a communication infrastructure 1106 (e.g., a bus). One or more processors 1104 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 also includes user input/output device(s) 1103, such as monitors, keyboards, pointing devices, etc., that communicate with communication infrastructure 1106 through user input/output interface(s) 1102.

Computer system 1100 also includes a main (or primary) memory 1108, such as random-access memory (RAM). Main memory 1108 may include one or more levels of cache. Main memory 1108 has stored therein control logic (i.e., computer software) and/or data. Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive. Removable storage drive 1114 may interact with a removable storage unit 1116. Removable storage unit 1116 includes a computer usable or readable storage device having stored thereon computer software (control logic) and/or data. Removable storage unit 1116 may be a floppy disk, magnetic tape, compact disk, DVD, optical storage disk, and/any other computer data storage device. Removable storage drive 1114 reads from and/or writes to removable storage unit 1116 in a well-known manner.

According to an exemplary embodiment, secondary memory 1110 may include other means, instrumentalities or other approaches for allowing computer programs and/or other instructions and/or data to be accessed by computer system 1100. Such means, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and universal serial bus (USB) port, a memory card and associated memory card slot, and/or any other removable storage unit and associated interface.

Computer system 1100 may further include a communication (or network) interface 1124. Communication interface 1124 enables computer system 1100 to communicate and interact with any combination of remote devices, remote networks, remote entities, etc. (individually and collectively referenced as 1126). For example, communication interface 1124 may allow computer system 1100 to communicate with remote devices 1126 over communication path 1128, which may be wired and/or wireless, and which may include any combination of LANs, WANs, the Internet, etc. Control logic and/or data may be transmitted to and from computer system 1100 via communication path 1128.

In an embodiment, a tangible apparatus or article of manufacture comprising a tangible computer useable or readable medium having control logic (software) stored thereon is also referred to herein as a computer program product or program storage device. This includes, but is not limited to, computer system 1100, main memory 1108, secondary memory 1110, and removable storage units 1116 and 1122, as well as tangible articles of manufacture embodying any combination of the foregoing. Such control logic, when executed by one or more data processing devices (such as computer system 1100), causes such data processing devices to operate as described herein.

Based on the teachings contained in this disclosure, it will be apparent to persons skilled in the relevant art(s) how to make and use embodiments of the present disclosure using data processing devices, computer systems and/or computer architectures other than that shown in FIG. 11. For example, embodiments may operate with software, hardware, and/or operating system implementations other than those described herein.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as a processor of video-processing system 250. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of video processing is provided. The method may include inputting, by a processor, attribute data and a sparse-depth map associated with an image area into a sparse-depth completion network. The method may include generating, by the processor, a refined dense-depth map based on the attribute data and the sparse-depth map using the sparse-depth completion network. The method may include performing, by the processor, a 3D-reconstruction procedure based on the refined dense-depth map to generate a point cloud of the image area. The method may include performing, by the processor, a triangular-meshing procedure to generate a mesh model based on the point cloud of the image area. The method may include performing, by the processor, a texture-mapping procedure based on the mesh model and the attribute data to generate a textured mesh of the image area. The method may include performing, by the processor, a vertex-normal procedure based on the textured mesh to generate a 3D representation of the image area.

In some embodiments, the generating, by the processor, the refined dense-depth map based on the attribute data and the sparse-depth map using the sparse-depth completion network includes generating, by an encoder, a plurality of feature maps based on the attribute data and the sparse-depth map of the image area. In some embodiments, the generating, by the processor, the refined dense-depth map based on the attribute data and the sparse-depth map using the sparse-depth completion network includes inputting, by the encoder, the plurality of feature maps into a first decoder and a second decoder. In some embodiments, the generating, by the processor, the refined dense-depth map based on the attribute data and the sparse-depth map using the sparse-depth completion network includes generating, by the first decoder, a first iterative-depth map of the image area and a multi-affinity matrix based on the plurality of feature maps. In some embodiments, the generating, by the processor, the refined dense-depth map based on the attribute data and the sparse-depth map using the sparse-depth completion network includes generating, by the second decoder, a plurality of adaptive features based on the plurality of feature maps.

In some embodiments, the generating, by the processor, the refined dense-depth map based on the attribute data and the sparse-depth map using the sparse-depth completion network includes inputting the sparse-depth map, the first iterative-depth map, and the plurality of adaptive features into a third decoder. In some embodiments, the generating, by the processor, the refined dense-depth map based on the attribute data and the sparse-depth map using the sparse-depth completion network includes generating, by the third decoder, a second iterative-depth map and the same multi-affinity matrix based on the sparse-depth map, the first iterative-depth map, and the plurality of adaptive features.

In some embodiments, the multi-affinity matrix may assign a first set of inter-pixel weights to pixels of the image area. In some embodiments, the multi-affinity matrix may assign a second set of inter-pixel weights to the pixels of the image area. In some embodiments, the first set of weights are different than the second set of weights.

In some embodiments, the generating, by the processor, the refined dense-depth map based on the attribute data and the sparse-depth map using the sparse-depth completion network further may include generating a coarse dense-depth map of the image area based on the first iterative-depth map and the second iterative-depth map. In some embodiments, the generating, by the processor, the refined dense-depth map based on the attribute data and the sparse-depth map using the sparse-depth completion network further may include inputting the multi-affinity matrix and the coarse dense-depth map into a CSPN++. In some embodiments, the generating, by the processor, the refined dense-depth map based on the attribute data and the sparse-depth map using the sparse-depth completion network further may include generating, by the CSPN++, the refined dense-depth map based on the multi-affinity matrix- and the coarse dense-depth map.

In some embodiments, the performing, by the processor, the 3D-reconstruction procedure based on the refined dense-depth map to generate the point cloud of the image area may include receiving a set of coordinates associated with the image area. In some embodiments, the performing, by the processor, the 3D-reconstruction procedure based on the refined dense-depth map to generate the point cloud of the image area may include mapping the set of coordinates associated with the image area to the refined dense-depth map. In some embodiments, the performing, by the processor, the 3D-reconstruction procedure based on the refined dense-depth map to generate the point cloud of the image area may include generating the point cloud based on the mapping of the set of coordinates associated with the image area to the refined dense-depth map.

In some embodiments, the performing, by the processor, the triangular-meshing procedure to generate the mesh model based on the point cloud of the image area identifying a plurality of nested surfaces in the point cloud based using a triangular-mesh model. In some embodiments, the performing, by the processor, the triangular-meshing procedure to generate the mesh model based on the point cloud of the image area generating the mesh model of the point cloud based on the plurality of nested surfaces.

In some embodiments, the mesh model may be a 3D surface model. In some embodiments, the triangular-mesh model may apply an alpha parameter to identify the plurality of nested surfaces. In some embodiments, the alpha parameter may be associated with a distance threshold for the 3D surface model.

In some embodiments, the performing, by the processor, the texture-mapping procedure based on the point cloud to generate the textured mesh of the image area may include mapping the attribute data onto the mesh model to generate the textured mesh.

In some embodiments, the performing, by the processor, the vertex-normal procedure based on the textured mesh to generate a 3D representation of the image area may include calculating a plurality of normal vector associated with each vertex in the textured mesh based on the attribute data. In some embodiments, the performing, by the processor, the vertex-normal procedure based on the textured mesh to generate a 3D representation of the image area may include generating the 3D representation of the image area based on the textured mesh and the plurality of normal vectors.

In some embodiments, the image area may be associated with a picture, a sub-picture, a tile, a slice, or a coding block. In some embodiments, the attribute data may include one or more of color data, reflectance data, or intensity data.

According to another aspect of the present disclosure, a system for video processing is provided. The system may include a processor and memory storing instructions. The memory storing instructions, which when executed by a processor, may cause the processor to input attribute data and a sparse-depth map associated with an image area into a sparse-depth completion network. The memory storing instructions, which when executed by a processor, may cause the processor to generate a refined dense-depth map based on the attribute data and the sparse-depth map using the sparse-depth completion network. The memory storing instructions, which when executed by a processor, may cause the processor to perform a 3D-reconstruction procedure based on the refined dense-depth map to generate a point cloud of the image area. The memory storing instructions, which when executed by a processor, may cause the processor to perform a triangular-meshing procedure to generate a mesh model based on the point cloud of the image area. The memory storing instructions, which when executed by a processor, may cause the processor to perform a texture-mapping procedure based on the mesh model and the attribute data to generate a textured mesh of the image area. The memory storing instructions, which when executed by a processor, may cause the processor to perform a vertex-normal procedure based on the textured mesh to generate a 3D representation of the image area.

In some embodiments, to generate the refined dense-depth map based on the attribute data and the sparse-depth map using the sparse-depth completion network, the memory storing instructions, which when executed by at least one processor, may cause the processor to generate, by an encoder, a plurality of feature maps based on the attribute data and the sparse-depth map of the image area. In some embodiments, to generate the refined dense-depth map based on the attribute data and the sparse-depth map using the sparse-depth completion network, the memory storing instructions, which when executed by at least one processor, may cause the processor to input, by the encoder, the plurality of feature maps into a first decoder and a second decoder. In some embodiments, to generate the refined dense-depth map based on the attribute data and the sparse-depth map using the sparse-depth completion network, the memory storing instructions, which when executed by at least one processor, may cause the processor to generate, by the first decoder, a first iterative-depth map of the image area and a multi-affinity matrix based on the plurality of feature maps. In some embodiments, to generate the refined dense-depth map based on the attribute data and the sparse-depth map using the sparse-depth completion network, the memory storing instructions, which when executed by at least one processor, may cause the processor to generate, by the second decoder, a plurality of adaptive features based on the plurality of feature maps.

In some embodiments, to generate the refined dense-depth map based on the attribute data and the sparse-depth map using the sparse-depth completion network, the memory storing instructions, which when executed by at least one processor, may cause the processor to input the sparse-depth map, the first iterative-depth map, and the plurality of adaptive features into a third decoder. In some embodiments, to generate the refined dense-depth map based on the attribute data and the sparse-depth map using the sparse-depth completion network, the memory storing instructions, which when executed by at least one processor, may cause the processor to generate, by the third decoder, a second iterative-depth map and a second multi-affinity matrix based on the sparse-depth map, the first iterative-depth map, and the plurality of adaptive features based on the sparse-depth map, the first iterative-depth map, and the plurality of adaptive features.

In some embodiments, the multi-affinity matrix may assign a first set of inter-pixel weights to pixels of the image area. In some embodiments, the multi-affinity matrix may assign a second set of inter-pixel weights to the pixels of the image area. In some embodiments, the first set of weights may be different than the second set of weights.

In some embodiments, to generate the refined dense-depth map based on the attribute data and the sparse-depth map using the sparse-depth completion network, the memory storing instructions, which when executed by at least one processor, may cause the processor to generate a coarse dense-depth map of the image area based on the first iterative-depth map and the second iterative-depth map. In some embodiments, to generate the refined dense-depth map based on the attribute data and the sparse-depth map using the sparse-depth completion network, the memory storing instructions, which when executed by at least one processor, may cause the processor to input the multi-affinity matrix and the coarse dense-depth map into a CSPN++. In some embodiments, to generate the refined dense-depth map based on the attribute data and the sparse-depth map using the sparse-depth completion network, the memory storing instructions, which when executed by at least one processor, may cause the processor to generate, by the CSPN++, the refined dense-depth map based on the first multi-affinity matrix, the second multi-affinity matrix, and the coarse dense-depth map.

In some embodiments, to perform the 3D-reconstruction procedure based on the refined dense-depth map to generate the point cloud of the image area, the memory storing instructions, which when executed by at least one processor, may cause the processor to receive a set of coordinates associated with the image area. In some embodiments, to perform the 3D-reconstruction procedure based on the refined dense-depth map to generate the point cloud of the image area, the memory storing instructions, which when executed by at least one processor, may cause the processor to map the set of coordinates associated with the image area to the refined dense-depth map. In some embodiments, to perform the 3D-reconstruction procedure based on the refined dense-depth map to generate the point cloud of the image area, the memory storing instructions, which when executed by at least one processor, may cause the processor to generate the point cloud based on the mapping of the set of coordinates associated with the image area to the refined dense-depth map.

In some embodiments, to perform the triangular-meshing procedure to generate the mesh model based on the point cloud of the image area, the memory storing instructions, which when executed by at least one processor, may cause the processor to identify a plurality of nested surfaces in the point cloud based using a triangular-mesh model. In some embodiments, to perform the triangular-meshing procedure to generate the mesh model based on the point cloud of the image area, the memory storing instructions, which when executed by at least one processor, may cause the processor to generate the mesh model of the point cloud based on the plurality of nested surfaces.

In some embodiments, the mesh model may be a 3D surface model. In some embodiments, the triangular-mesh model may apply an alpha parameter to identify the plurality of nested surfaces. In some embodiments, the alpha parameter may be associated with a distance threshold for the 3D surface model.

In some embodiments, to perform the texture-mapping procedure based on the point cloud to generate the textured mesh of the image area, the memory storing instructions, which when executed by at least one processor, may cause the processor to map the attribute data onto the mesh model to generate the textured mesh.

In some embodiments, to perform the vertex-normal procedure based on the textured mesh to generate a 3D representation of the image area, the memory storing instructions, which when executed by at least one processor, may cause the processor to calculate a plurality of normal vector associated with each vertex in the textured mesh based on the attribute data. In some embodiments, to perform the vertex-normal procedure based on the textured mesh to generate a 3D representation of the image area, the memory storing instructions, which when executed by at least one processor, may cause the processor to generate the 3D representation of the image area based on the textured mesh and the plurality of normal vectors.

In some embodiments, the image area may be associated with a picture, a sub-picture, a tile, a slice, or a coding block. In some embodiments, the attribute data may include one or more of color data, reflectance data, or intensity data.

According to a further aspect of the present disclosure, a non-transitory computer-readable medium is provided. The non-transitory computer-readable medium storing instructions. The instructions, when executed by a processor of a video-processing system, cause the processor to input attribute data and a sparse-depth map associated with an image area into a sparse-depth completion network. The instructions, which when executed by a processor of a video-processing system, cause the processor to generate a refined dense-depth map based on the attribute data and the sparse-depth map using the sparse-depth completion network. The instructions, which when executed by a processor of a video-processing system, cause the processor to perform a 3D-reconstruction procedure based on the refined dense-depth map to generate a point cloud of the image area. The instructions, which when executed by a processor of a video-processing system, cause the processor to perform a triangular-meshing procedure to generate a mesh model based on the point cloud of the image area. The instructions, which when executed by a processor of a video-processing system, cause the processor to perform a texture-mapping procedure based on the mesh model and the attribute data to generate a textured mesh of the image area. The instructions, which when executed by a processor of a video-processing system, cause the processor to perform a vertex-normal procedure based on the textured mesh to generate a 3D representation of the image area.

In some embodiments, to generate the refined dense-depth map based on the attribute data and the sparse-depth map using the sparse-depth completion network, the instructions, which when executed by at least one processor, may cause the processor to generate, by an encoder, a plurality of feature maps based on the attribute data and the sparse-depth map of the image area. In some embodiments, to generate the refined dense-depth map based on the attribute data and the sparse-depth map using the sparse-depth completion network, the instructions, which when executed by at least one processor, may cause the processor to input, by the encoder, the plurality of feature maps into a first decoder and a second decoder. In some embodiments, to generate the refined dense-depth map based on the attribute data and the sparse-depth map using the sparse-depth completion network, the instructions, which when executed by at least one processor, may cause the processor to generate, by the first decoder, a first iterative-depth map of the image area and a multi-affinity matrix based on the plurality of feature maps. In some embodiments, to generate the refined dense-depth map based on the attribute data and the sparse-depth map using the sparse-depth completion network, the instructions, which when executed by at least one processor, may cause the processor to generate, by the second decoder, a plurality of adaptive features based on the plurality of feature maps.

In some embodiments, to generate the refined dense-depth map based on the attribute data and the sparse-depth map using the sparse-depth completion network, the instructions, which when executed by at least one processor, may cause the processor to input the sparse-depth map, the first iterative-depth map, and the plurality of adaptive features into a third decoder. In some embodiments, to generate the refined dense-depth map based on the attribute data and the sparse-depth map using the sparse-depth completion network, the instructions, which when executed by at least one processor, may cause the processor to generate, by the third decoder, a second iterative-depth map and the same multi-affinity matrix based on the sparse-depth map, the first iterative-depth map, and the plurality of adaptive features.

In some embodiments, the multi-affinity matrix assigns a first set of inter-pixel weights to pixels of the image area. In some embodiments, the multi-affinity matrix may assign a second set of inter-pixel weights to the pixels of the image area. In some embodiments, the first set of weights may be different than the second set of weights.

In some embodiments, to generate the refined dense-depth map based on the attribute data and the sparse-depth map using the sparse-depth completion network, the instructions, which when executed by at least one processor, may cause the processor to generate a coarse dense-depth map of the image area based on the first iterative-depth map and the second iterative-depth map. In some embodiments, to generate the refined dense-depth map based on the attribute data and the sparse-depth map using the sparse-depth completion network, the instructions, which when executed by at least one processor, may cause the processor to input the multi-affinity matrix and the coarse dense-depth map into a CSPN++. In some embodiments, to generate the refined dense-depth map based on the attribute data and the sparse-depth map using the sparse-depth completion network, the instructions, which when executed by at least one processor, may cause the processor to generate, by the CSPN++, the refined dense-depth map based on the multi-affinity matrix and the coarse dense-depth map.

In some embodiments, to perform the 3D-reconstruction procedure based on the refined dense-depth map to generate the point cloud of the image area, the instructions, which when executed by at least one processor, may cause the processor to receive a set of coordinates associated with the image area. In some embodiments, to perform the 3D-reconstruction procedure based on the refined dense-depth map to generate the point cloud of the image area, the instructions, which when executed by at least one processor, may cause the processor to map the set of coordinates associated with the image area to the refined dense-depth map. In some embodiments, to perform the 3D-reconstruction procedure based on the refined dense-depth map to generate the point cloud of the image area, the instructions, which when executed by at least one processor, may cause the processor to generate the point cloud based on the mapping of the set of coordinates associated with the image area to the refined dense-depth map.

In some embodiments, to perform the triangular-meshing procedure to generate the mesh model based on the point cloud of the image area, the instructions, which when executed by at least one processor, may cause the processor to identify a plurality of nested surfaces in the point cloud based using a triangular-mesh model. In some embodiments, to perform the triangular-meshing procedure to generate the mesh model based on the point cloud of the image area, the instructions, which when executed by at least one processor, may cause the processor to generate the mesh model of the point cloud based on the plurality of nested surfaces.

In some embodiments, the mesh model may be a 3D surface model. In some embodiments, the triangular-mesh model applies an alpha parameter to identify the plurality of nested surfaces. In some embodiments, the alpha parameter is associated with a distance threshold for the 3D surface model.

In some embodiments, to perform the texture-mapping procedure based on the point cloud to generate the textured mesh of the image area, the instructions, which when executed by at least one processor, may cause the processor to map the attribute data onto the mesh model to generate the textured mesh.

In some embodiments, to perform the vertex-normal procedure based on the textured mesh to generate a 3D representation of the image area, the instructions, which when executed by at least one processor, may cause the processor to calculate a plurality of normal vector associated with each vertex in the textured mesh based on the attribute data. In some embodiments, to perform the vertex-normal procedure based on the textured mesh to generate a 3D representation of the image area, the instructions, which when executed by at least one processor, may cause the processor to generate the 3D representation of the image area based on the textured mesh and the plurality of normal vectors.

In some embodiments, the image area may be associated with a picture, a sub-picture, a tile, a slice, or a coding block. In some embodiments, the attribute data may include one or more of color data, reflectance data, or intensity data.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method of video processing comprising:
inputting, by a processor, attribute data and a sparse-depth map associated with an image area into a sparse-depth completion network;
generating, by the processor, a refined dense-depth map based on the attribute data and the sparse-depth map using the sparse-depth completion network;
performing, by the processor, a three-dimensional (3D) reconstruction procedure based on the refined dense-depth map to generate a point cloud of the image area;
performing, by the processor, a triangular-meshing procedure to generate a mesh model based on the point cloud of the image area;
performing, by the processor, a texture-mapping procedure based on the mesh model and the attribute data to generate a textured mesh of the image area; and
performing, by the processor, a vertex-normal procedure based on the textured mesh to generate a 3D representation of the image area.

2. The method of claim 1, wherein the generating, by the processor, the refined dense-depth map based on the attribute data and the sparse-depth map using the sparse-depth completion network comprises:
generating, by an encoder, a plurality of feature maps based on the attribute data and the sparse-depth map of the image area;
inputting, by the encoder, the plurality of feature maps into a first decoder and a second decoder;
generating, by the first decoder, a first iterative-depth map of the image area and a multi-affinity matrix based on the plurality of feature maps; and
generating, by the second decoder, a plurality of adaptive features based on the plurality of feature maps.

3. The method of claim 2, wherein the generating, by the processor, the refined dense-depth map based on the attribute data and the sparse-depth map using the sparse-depth completion network further comprises:
inputting the sparse-depth map, the first iterative-depth map, and the plurality of adaptive features into a third decoder; and
generating, by the third decoder, a second iterative-depth map and the same multi-affinity matrix based on the sparse-depth map, the first iterative-depth map, and the plurality of adaptive features.

4. The method of claim 3, wherein:
the multi-affinity matrix assigns a first set of inter-pixel weights to pixels of the image area,
the multi-affinity matrix assigns a second set of inter-pixel weights to the pixels of the image area, and
the first set of weights are different than the second set of weights.

5. The method of claim 3, wherein the generating, by the processor, the refined dense-depth map based on the attribute data and the sparse-depth map using the sparse-depth completion network further comprises:
generating a coarse dense-depth map of the image area based on the first iterative-depth map and the second iterative-depth map;
inputting the multi-affinity matrix and the coarse dense-depth map into convolutional spatial propagation networks (CSPN++); and
generating, by the CSPN++, the refined dense-depth map based on the multi-affinity matrix and the coarse dense-depth map.

6. The method of claim 1, wherein the performing, by the processor, the 3D-reconstruction procedure based on the refined dense-depth map to generate the point cloud of the image area comprises:
receiving a set of coordinates associated with the image area;
mapping the set of coordinates associated with the image area to the refined dense-depth map; and
generating the point cloud based on the mapping of the set of coordinates associated with the image area to the refined dense-depth map.

7. The method of claim 1, wherein the performing, by the processor, the triangular-meshing procedure to generate the mesh model based on the point cloud of the image area comprises:
identifying a plurality of nested surfaces in the point cloud based using a triangular-mesh model; and
generating the mesh model of the point cloud based on the plurality of nested surfaces.

8. The method of claim 7, wherein:
the mesh model is a 3D surface model,
the triangular-mesh model applies an alpha parameter to identify the plurality of nested surfaces, and
the alpha parameter is associated with a distance threshold for the 3D surface model.

9. The method of claim 1, wherein the performing, by the processor, the texture-mapping procedure based on the point cloud to generate the textured mesh of the image area comprises:
mapping the attribute data onto the mesh model to generate the textured mesh.

10. The method of claim 1, wherein the performing, by the processor, the vertex-normal procedure based on the textured mesh to generate a 3D representation of the image area comprises:
calculating a plurality of normal vectors associated with each vertex in the textured mesh based on the attribute data; and
generating the 3D representation of the image area based on the textured mesh and the plurality of normal vectors.

11. The method of claim 1, wherein:
the image area is associated with a picture, a sub-picture, a tile, a slice, or a coding block, and
the attribute data includes one or more of color data, reflectance data, or intensity data.

12. A system for video processing, comprising:
a processor; and
memory storing instructions, which when executed by at least one processor, cause the processor to:
input attribute data and a sparse-depth map associated with an image area into a sparse-depth completion network;
generate a refined dense-depth map based on the attribute data and the sparse-depth map using the sparse-depth completion network;
perform a three-dimensional (3D) reconstruction procedure based on the refined dense-depth map to generate a point cloud of the image area;
perform a triangular-meshing procedure to generate a mesh model based on the point cloud of the image area;
perform a texture-mapping procedure based on the mesh model and the attribute data to generate a textured mesh of the image area and
perform a vertex-normal procedure based on the textured mesh to generate a 3D representation of the image area.

13. The system of claim 12, wherein, to generate the refined dense-depth map based on the attribute data and the sparse-depth map using the sparse-depth completion network, the memory storing instructions, which when executed by at least one processor, cause the processor to:
generate, by an encoder, a plurality of feature maps based on the attribute data and the sparse-depth map of the image area;
input, by the encoder, the plurality of feature maps into a first decoder and a second decoder;
generate, by the first decoder, a first iterative-depth map of the image area and a multi-affinity matrix based on the plurality of feature maps; and
generate, by the second decoder, a plurality of adaptive features based on the plurality of feature maps.

14. The system of claim 13, wherein, to generate the refined dense-depth map based on the attribute data and the sparse-depth map using the sparse-depth completion network, the memory storing instructions, which when executed by at least one processor, cause the processor to:
input the sparse-depth map, the first iterative-depth map, and the plurality of adaptive features into a third decoder; and
generate, by the third decoder, a second iterative-depth map and the same multi-affinity matrix based on the sparse-depth map, the first iterative-depth map, and the plurality of adaptive features.

15. The system of claim 14, wherein:
the multi-affinity matrix assigns a first set of inter-pixel weights to pixels of the image area,
the multi-affinity matrix assigns a second set of inter-pixel weights to the pixels of the image area, and
the first set of weights are different than the second set of weights.

16. The system of claim 14, wherein, to generate the refined dense-depth map based on the attribute data and the sparse-depth map using the sparse-depth completion network, the memory storing instructions, which when executed by at least one processor, cause the processor to:
generate a coarse dense-depth map of the image area based on the first iterative-depth map and the second iterative-depth map;
input the multi-affinity matrix and the coarse dense-depth map into convolutional spatial propagation networks (CSPN++); and
generate, by the CSPN++, the refined dense-depth map based on the multi-affinity matrix and the coarse dense-depth map.

17. The system of claim 12, wherein, to perform the 3D-reconstruction procedure based on the refined dense-depth map to generate the point cloud of the image area, the memory storing instructions, which when executed by at least one processor, cause the processor to:
receive a set of coordinates associated with the image area;
map the set of coordinates associated with the image area to the refined dense-depth map; and
generate the point cloud based on the mapping of the set of coordinates associated with the image area to the refined dense-depth map.

18. The system of claim 12, wherein, to perform the triangular-meshing procedure to generate the mesh model based on the point cloud of the image area, the memory storing instructions, which when executed by at least one processor, cause the processor to:
identify a plurality of nested surfaces in the point cloud based using a triangular-mesh model; and
generate the mesh model of the point cloud based on the plurality of nested surfaces.

19. The system of claim 18, wherein:
the mesh model is a 3D surface model,
the triangular-mesh model applies an alpha parameter to identify the plurality of nested surfaces, and
the alpha parameter is associated with a distance threshold for the 3D surface model.

20. A non-transitory computer-readable medium storing instructions, which when executed by a processor of a video-processing system, cause the processor to:
input attribute data and a sparse-depth map associated with an image area into a sparse-depth completion network;
generate a refined dense-depth map based on the attribute data and the sparse-depth map using the sparse-depth completion network;
perform a three-dimensional (3D) reconstruction procedure based on the refined dense-depth map to generate a point cloud of the image area;
perform a triangular-meshing procedure to generate a mesh model based on the point cloud of the image area;
perform a texture-mapping procedure based on the mesh model and the attribute data to generate a textured mesh of the image area; and
perform a vertex-normal procedure based on the textured mesh to generate a 3D representation of the image area.
